(19) United States
(12) Patent Application Publication
(10) Pub. No.: US 2017/0223904 A1
(43) Pub. Date: Aug. 10, 2017

(54) Fodder Growing System and Method

(71) Applicant: Fodder Solutions Holdings Pty Ltd, Burleigh Heads (AU)

(72) Inventor: Flavio Raccanello, Burleigh Heads (AU)

(21) Appl. No.: 15/494,488

(22) Filed: Apr. 22, 2017

Related U.S. Application Data
(63) Continuation-in-part of application No. PCT/AU2015/050665, filed on Oct. 26, 2015.

(30) Foreign Application Priority Data
Oct. 24, 2014 (AU) 2014904268

(51) Int. Cl. A01G 9/00; A01G 7/04; A01G 25/16; E04C 2/292; A01G 9/02; E04H 5/08; E04B 1/08; E04B 1/19; A01C 7/08; A01G 9/10

(52) U.S. Cl. CPC A01G 9/00; A01C 7/08; A01G 7/045; A01G 25/165; A01G 9/10; A01G 9/022; E04H 5/08; E04B 1/08; E04B 1/19; E04C 2/292; E04H 2001/1283

(57) ABSTRACT

A fodder growing apparatus includes an insulated housing having a draining floor, a door-closable open face, and a plurality of vertically-spaced platforms being supported in a position inclined downward between 3° and about 6°. The apparatus further includes pass-through irrigation system including spray nozzles supported over each of the platforms and supplied with water. An illumination system of the apparatus includes an LED equipped lighting assembly supported over each of the platforms. A ventilation system of the apparatus includes forced ventilation means. The apparatus further includes a programmable controller selected to deliver a time-variant program of at least irrigation and lighting, and temperature control means controlling the temperature within the housing.

### CROSS-REFERENCE TO RELATED APPLICATIONS

This application is a continuation-in-part of International Patent Application No. PCT/AU2015/050665 filed 26 Oct. 2015 (and published as WO 2016/061637 A1) which designates the United States of America and claims priority of Australian Provisional Application No. 2014904268 filed 24 Oct. 2014, the entire content of each of these prior applications is incorporated herein by reference.

### FIELD OF THE INVENTION

This invention relates to fodder growing, and more particularly to a system and method for growing fodder.

### DISCUSSION OF RELATED ART

It will be clearly understood that, if a prior art publication is referred to herein, this reference does not constitute an admission that the publication forms part of the common general knowledge in the art in Australia or in any other country.

The challenge of providing nutritious animal feed in times of seasonal shortage has been met throughout the history of animal husbandry by many processes. In highly seasonal regions, landscapes have been made over to meadowing for the purposes of seasonal hay production. Silage crops may be put in, harvested and appropriately stored. These historically European methods are not always available for use in other environments lacking the land, climate or culture of husbandry to put in adequate feed stocks.

In many parts of the world, land may be plentiful but growing conditions are poor. Temperatures and/or rainfall may be too extreme to grow fodder dependably throughout the year. In such situations, pastoralists need to buy feed from outside sources, which is generally more expensive than growing the feed themselves. Therefore, there is a need for a growing system and methods that allows farmers to grow fodder for livestock in conditions where the general conditions are not favourable for growing fodder.

There have been many proposals for such a system. The applicant's own Australian Patent Application No. 2007201138 provided a transportable fodder production unit comprising an insulated container. The insulated container contained a racking system, an irrigation system, a lighting system and a thermal control system. The racking system had a plurality of shelves extending from the rear of the container to the front of the container, the shelves being of sufficient width to receive at least one fodder growing tray and of sufficient depth to receive a predetermined number of rows of trays to cycle through the container in a growing period. By this means, seeded trays can be loaded onto the rear of the shelves and trays with mats of grown fodder can be removed from the front of the shelves, said trays being urged forward by an operator as the fodder progresses through the growing period.

The irrigation system comprised a plurality of spray heads positioned in the racking system for periodically spraying each tray with a predetermined volume of water. The lighting system was empirically operated fluorescent lighting to maintain a predetermined illumination. The thermal control unit comprised a reverse cycle AC unit to maintain the temperature within a predetermined temperature range.

This system and the method of its use had the advantage of portability, and were widely copied in Africa.

Later developments of the system evolved to fixed installations comprising a purpose-built building, preferably insulated and including a vertical array of slabs each having a top surface to support plants grown from seed on the slabs, spacing members arranged to vertically separate adjacent slabs, an irrigation system having outlets located to water the plants, and heating pipes associated with each slab for circulating a fluid therethrough for maintaining the plants within a temperature range for enhanced growth. Specific embodiments included a method for growing plants including providing such a vertical array of slabs each including a heat exchange pipe, distributing plant seeds on top surfaces of the slabs, providing an automated irrigation system to irrigate the seeds based on an irrigation schedule, and applying light to the top surfaces of the slabs to encourage growth of the seeds. An additional step of forcing air over the top surfaces of the slabs to ventilate the plants provided multiple benefits.

The energy demands of the system were moderated by the heating of the thermally massive slabs via the heat exchange pipes. Circulating liquids in the heat exchange pipe system may be heated by solar thermal means. However, the slabs are inherently heavy and expensive to transport. In order that the slabs are able to be handled, they are inherently restricted in size. Circulated heat exchange piping represents an installation and operational complexity.

The present invention has an object of providing an alternative to the foregoing state of the art installations and having specific benefits thereover.

### SUMMARY OF THE INVENTION

According to a first aspect of the present invention there is provided a fodder growing system including:

an insulated housing having a draining floor portion and at least one loading and unloading opening;

a plurality of vertically-spaced platforms supported in said housing, each platform being bounded by spaced end wall portions interconnected by a rear wall portion and an open front edge portion, the platforms being supported in a position inclined downwardly from said rear wall to said front edge, said front edges being accessible from said opening;

an irrigation system including spray nozzles supported over each of said platforms and supplied with water;

an illumination system supported over each of said platforms;

a ventilation system including forced ventilation means; and

a programmable controller selected to deliver a time-variant program of at least irrigation, lighting and temperature control.

According to a second aspect of the present invention there is provided a fodder growing system including:

an insulated housing having a draining floor portion and at least one loading and unloading opening;

a plurality of vertically-spaced, polymer platforms supported in said housing, each platform being bounded by integral, spaced end wall portions interconnected by an integral rear wall portion and an open front edge portion, the polymer platforms being supported in a position inclined downward between 3° and about 6° from the horizontal from said rear wall to said front edge, said front edges being accessible from said opening;

a pass-through irrigation system including spray nozzles supported over each of said platforms and supplied with temperature controlled water;

an illumination system including LED equipped lighting assembly supported over each of said platforms;

a ventilation system including forced ventilation means; and

a programmable controller selected to deliver a time-variant program of at least irrigation, lighting and temperature control, said temperature control including controlling the temperature of said temperature controlled water.

The housing may take the form of a slab-on-ground or suspended floor building. The building may be formed of metal-clad insulated panels, either as a stressed-skin structure or fully or partially framed. The at least one loading and unloading opening may comprise a door; this may comprise one or more of a simple personal access door, and one or more doors admitting trolleys or carts for moving seed in and produce out.

The housing may comprise a building having a floor, two opposed end walls and two opposed side walls interconnecting the end walls, the side and end walls being formed of insulated panels, an insulated-panel top wall comprising both roof and ceiling of the building, and a pair of doors selectively closing respective opposed openings in the end walls. The opposed openings may define a passage through the building, and may be provided with on and/or off ramps as required. The passage may be defined within the housing by arrays of the platforms on one or both sides of the passage, presenting the open front edges to the passage. The housing may accommodate any selected number of platform members in adjacent relation, confined only by the dimensions of the housing. Having an opening door at either end of the passage enables cooling of enclosure in summer by way of ventilation of air mass in room.

The housing may comprise a transportable or fixed structure. The housing may have one or more features as described for the fifth aspect of the present invention.

In the case of a transportable structure, the housing may include the general plan of an ISO container such as a standard or high-cube shipping container. That is, the housing may resemble a transportable shipping container. In this case, the at least one loading and unloading opening may comprise opening side panels forming part of the side walls of the housing. The side panels may for example be insulated door panels swung on upright door frame members. The container-housing is preferable supported on a concrete slab in use but may be supported on blocks or the like, provided that drainage is adequate. It may be advantageous to block-support the container with blocks located under the floor portion of the container at the upright door frame member locations to share bending loads between the container floor and top walls.

The floor of the housing may be flat or may slope to a drain. For container style housings, a flat floor may be made to drain by installing on suitable blocks.

The programmable controller and other potentially sensitive equipment may be isolated from the relatively warm and humid interior of the housing. For example, a building may be provided with an interior or exterior substantially sealed control equipment locker. In the case of a container style housing, a control locker may be formed by a false end wall set in from one end of the container to form a recess. Control and operating equipment mounted in the recess may be protected from the elements and tampering by a door or the like closing the end of the housing. Roller doors are preferred in this instance since the roller may be partially opened for ventilation when not secured. The control locker may be configured to be large enough to include a temperature controlled water holding tank forming the water supply.

Each platform may be of any suitable size, shape and construction, and may be made of any suitable material or materials. For example, each platform may be made of metal or plastics material. Each platform may have one or more features as described for the fifth aspect of the present invention, although referred to in that aspect as a fodder-growth surface. In some embodiments, polymer platforms may comprise a moulded thermoset, two-pack or thermoplastic polymer or polymer composite material. The polymer platforms may be vacuum or die formed. Examples of thermo vacuum-formable sheet thermoplastic for use in forming the polymer platforms are ABS, HDPE or PP. Examples of vacuum-formable thermoset or two pack prepregs include epoxy, polyester and vinyl ester sheet moulding compounds.

In some embodiments each platform may be bounded by integral, spaced end wall portions interconnected by an integral rear wall portion and an open front edge portion.

Each platform may be supported in a downwardly inclined position in any suitable way. Each platform may be downwardly inclined at any suitable angle relative to the horizontal, so as to enable drainage of water downwardly along a growing/growth surface of the platform. For example, the angle of inclination may be approximately 0.5°, 1°, 1.5°, 2°, 2.5°, 3°, 3.5°, 4°, 4.5°, 5°, 5.5°, 6° or even greater. In some embodiments the platforms may be supported in a position inclined downward between 2° and about 6° from the horizontal from said rear wall to said front edge.

The platforms have an open front edge, that is, a front edge that is substantially unobstructed. By this means fodder mat grown on the platform may be readily stripped with the assistance of gravity by sliding the mat off the front edge. The platforms may comprise a single flat growing surface. However, in the interests of platform stiffness and controlling fodder mat size and thus weight the growing platform may be formed with one or more dividing walls extending from the rear wall portion toward the front edge. The dividing wall portions may be thermoformed as a flattened, vertical re-entrant. The end wall portions, rear wall portion and any dividing wall portions may rise about 50 mm above the platform surface to provide sufficient separation.

The platforms may be formed as a self-supporting sheet of material, or may comprise a metal frame assembly supporting a plurality of platform members. For example, the metal frame assembly may comprise a frame and/or stringer assembly with platform members each comprising a sheet of material supported by it. The material is preferably a chemically and biologically inert, waterproof and non-absorbent surface.

The platforms may be supported in the housing on a metal frame assembly comprising substantially vertical support members located adjacent selected end wall portions and cooperating with at least two spaced platform support bars interconnecting the vertical support members and supporting the platform. For example, there may be provided a metal framing arrangement wherein the metal frame assembly comprises a thermal mass formed of aluminium box section and comprising uprights supporting stringers supporting or suspending the platform members. The spaced end portions may comprise respective end edges of the platform, meeting the front and rear edges at respective corners. An upright may support the platform and be located at a selected position adjacent an end edge between the respective corners.

The platforms may possess any selected vertical spacing dependent on the need for overhead clearance for growth, the need for irrigation and lighting to be above the maximum sprout height, and the desire for the most intensive agriculture per square meter of footprint.

The metal framing arrangement may be of any selected material. For cost and relative ease of fabrication, the metal framing arrangement components such as the uprights may comprise RHS or open channel metal such as steel or aluminium. The metal may be coated such as by painting or powder coating to reduce corrosion, or may be passivated or anodically protected against corrosion such as by electrolytic or hot-dip galvanizing, zinc-aluminium coating or the like. Preferably the metal framing is of relatively heavy wall section aluminium, such as 3-4 mm wall aluminium RHS section of 40-50 mm size. By this means the framing contributes significantly to the thermal mass of the assembly.

The metal framing arrangement between the uprights will be selected having regard to the physical parameters of the platform per se. The seed bed at the beginning of the process is light; the fodder mat produced therefrom is heavy. The platform must resist considerable static loads without appreciable bending during the growing phase, and significant dynamic loads at the time of fodder mat stripping. While the platforms may be selected to be stiff and strong enough to be supported only at the end portions, it is preferred to support each of the platform members on at least one stringer located beneath the platform and extending between the respective end portions, the platform load on the stringer being translated to the uprights.

The uprights may comprise pairs of spaced uprights located at selected ones of the end portions of the platform, the pairs at each end being interconnected by a cross member. The cross members may be interconnected by one or more stringers extending between the end portions and supporting the platform from underneath. At least some of the stringers may be located to provide a scaffold for supporting at least some elements of the irrigation and illumination systems.

The metal framing arrangement may support the platforms presenting a flat upper growing surface at an angle between about 2° and about 6° (more preferably between about 3° and about 6°) from the horizontal and selected to retain the fodder seed bed during set up and germination phases, while providing adequate drainage. Seed bed retention involves control of many variables, including irrigation parameters, seeding rates and surface energy, as well as growing surface inclination. Drainage similarly is subject to many variables including but not limited to seed coat wettability, wettability of the growing surface of the platform, seed size and shape and its influence on capillary action in the seed bed, as well as inclination of the platform growing surface.

From the point of view of fodder feed sprouting grains using water irrigation, these require significant mechanical (i.e. forced impingement spray) wetting by the irrigation system, and tend to slump at seed loadings of more than 4.5 kg m⁻² for angles on inclination over 5° from the horizontal. However, drainage is highly variable with a mixture of dry and sodden patches, with sodden patches predominating at less than 6° inclination. Sodden patches promote seed rot and drowning of plantlets; dry patched do not germinate vigorously.

It has been surprisingly determined that high seeding rates in excess of 8 kg m⁻² may be used, with adequate resistance to slumping of the seed mass under gravity, and with adequate drainage, on flat growing surfaces maintained at an inclination of about 4° from the horizontal. This is contrary to all prior art teaching and relies on carefully selected process conditions as described hereinafter. The platforms may comprise platform members each having a flat upper growing surface, wherein the inclination downward is selected from between 3° and about 6° from the horizontal, in choosing one or more of these process conditions. For reasons given hereinafter, it may be preferred to incline the flat upper growing surface at about 4° from the horizontal.

The essentially uninterrupted growing surface of the platform encourages simple raking to distribute seed for sprouting thereon. For example a simple straight edged paddle or gauge rake may be provided with a pair of spaced prongs to contact the surface and define an opening bounded by the surface, prongs and straight edge, the opening corresponding to a selected profile of the seed bed. The seed may be shoveled onto the platform then distributed with the gauge rake, the prongs controlling the seed bed depth.

Where the platforms are divided by one or more intermediate walls, these may be conveniently selected as to placement to control the size of the fodder mat portion or “biscuit”. To control overgrowth of the fodder mat adjacent the intermediate walls is to assist in preventing entanglement between adjacent biscuits. To this end the seed bed may be relieved or shallower at the sides adjacent at least the intermediate walls. For example there may be provided a seed bed loader whereby a charge of seed suitable for a single biscuit may be loaded in the loader. The loader may be inserted over the selected platform portion and operated to deposit seed preferentially away from the intermediate wall(s). Of course, the transverse dimension of the seed bed is preferably maximized.

In one embodiment, the loader comprises an elongate tray of arcuate cross section, which is a little shorter than the distance from the rear wall and front edge of the platform. The width of the elongate tray may be just a little less than the spaces between side walls and intermediate walls. The elongate tray may have one open arcuate end and one walled arcuate end. The opposed elongate edges of the tray may support short pieces of low friction plastic edging at the open end. The walled arcuate end may bear a handle, the use of which will become apparent.

The seed loader of this embodiment may have one or more features of the seed loader as described according to the sixth and seventh embodiments of the invention.

In use the seed mass (soaked if necessary) may be loaded in to the loader tray. The loaded loader tray may be inserted between the vertically spaced platforms and rotated by the handle to dump the seed mass on the lower platform between a pair of intermediate walls or a side wall and intermediate wall, as the case requires. The inverted tray may then be withdrawn with the low friction plastic edging bearing on the platform and the open arcuate end serving to evenly distribute the seed bed on the platform. The impingement of the arcuate section of the open end on the seed bed results in a seed bed that is relatively thin adjacent the side walls and intermediate walls, reducing the tendency to overgrowth and entanglement of adjacent biscuits.

In the fixed building embodiments having a corridor, the combination of the platforms sloping to a corridor space in the housing, and the lack of any lip, drain, upright or other impediment, enables the grown fodder mat grown to substantially the full length and breadth of the growing surface to be stripped off by sliding over the front edge. This is readily achievable by hand. Where the mat is heavy; it may be stripped to fall directly into a low cart that may enter the corridor though the opening in one end of the housing, and is wheelable to exit the opening in the other end of the housing. The platform is not removed at any time in the process.

In the transportable embodiments of the present invention, the mat may be similarly dropped of the open front edge, but through at least one loading and unloading opening though the housing wall.

The irrigation system may include a water supply selected from one or more of water storage means and a reticulated supply. For remote area use the water supply may be drawn from a rainwater collection point such as a tank or impoundment. In certain embodiments the water supply may include water collection means utilizing the roof of the housing as a water collection surface.

The irrigation system may include a pump or may utilize a pre-existing head pressure of the water supply.

The irrigation system is preferably, but optionally, “pass through” in that the water that passes off the platforms to the draining floor portion is not recycled to the seed beds in the condition as drained. This limits potential for infection of the seed mat, a common problem of hydroponic systems. Of course, treatment of waste water to an acceptable standard of purity is not excluded.

The irrigation system may include a pump and/or valves operated in accordance with a selected program to deliver irrigation water to the spray nozzles, depending on the nature of the water supply. The nozzles are preferably selected from low impact nozzles. For example the nozzles may deliver one of more of a spray component, a drip component and a mist component, for reasons that will become apparent hereinafter. The nozzles for a particular platform may be supported on the underside of the platform above; in the case of platforms supported on one or more stringers, the nozzles and the lead-in pipework supplying them may be supported on the stringer(s) as a scaffold.

In some embodiments the irrigation system conveys temperature controlled water. Preferably, the irrigation system is central to the process of controlling the temperature within the housing. Accordingly, the irrigation system is preferably provided with means of varying the temperature of the water from the water supply, as described hereinafter. The irrigation system cooperates with the insulative properties of the housing and the thermal mass properties of the housing contents to stabilize the growing temperature.

The irrigation system may further include treatment means for the irrigation water.

The sprouting processes for which the apparatus of the present invention find use are not hydroponic processes; the processes are kept essentially nutrient-free to suppress the growth of microbiological contaminants. However, pre-dosing of the irrigation water with microbial suppressants, surface active agents and the like may be performed. Pre-dosing may be by dosing a water supply storage or by metered injection into delivery pipes to the sprinkler nozzles. Pre-treatment may include ozonation of the water supply. Pre-treatment may include dosing the water supply with a food grade non-ionic surfactant. Specific examples are described hereinafter with reference to the methods of the present invention.

The illumination system may be selected from fluorescent, incandescent or electronic lighting such as light emitting diode (LED) arrays. From the point of view of sheer efficiency, the use of LED arrays provides a substantial benefit. However, there are colour spectrum issues to address, and the capital cost of high intensity LEDs capable of delivering useful flux is relatively high. Fluorescent lighting has a relatively broad visible spectrum including frequencies not absorbed by photosynthetic (e.g. chlorophyll) and other metabolic chromophores. Efficiency losses via heating of transformer/ballast assemblies and cathode heating are significant. In the case of incandescent lighting, in extremely cold climates the high heat yield per lumen that would otherwise be an exorbitant energy impost may be tolerated. However, the radiant heat would in general be too extreme for the vertical densities considered economic. It is accordingly preferred to select the lighting from fluorescent lighting and LED lighting. Further efficiency may be obtained by leaving the illumination off during early-phase, non-photosynthetic germination.

The ventilation system is selected in order to control the O₂/CO₂ balance and condensing atmosphere in the housing. During a lighting cycle late in the growing phase, the fodder mat is both respiring (i.e. using O₂) and photosynthesizing (i.e. using CO₂ but generating O₂). However, all through the germination stage and until the biomass of cells including chloroplasts predominates, the plants are exclusively respiring, which can cause the O₂ level to drop significantly below the normal 159 mm Hg partial pressure. There may be provided a fan assembly operable as one or more of a blower, extractor or recirculator of the air inside the housing. The fan assembly is preferably located high in the housing to work in the “hot zone” and to avoid ground level dust and dirt being injected. The ventilation may be operable by control means to effect a fresh air change, which is needed to balance the air composition in the housing and to inhibit the growth of moulds. For example there may be provided a purge program for a fresh air change of about two housing volumes per day. The ventilation may include air conditioning means for use in extreme external environmental conditions. The ventilation arrangement may include selective or incidental operation of the doors.

While the sugar factory of photosynthetic plants is in the chloroplasts containing chlorophyll, there are many chromophores-bearing organic substances that contribute to plant metabolism and may be stimulated by light to encourage growth and productions. For example, while chlorophyll itself has two sharp absorption peaks at about 460 nm and about 665 nm, biologically important anthocyanins have peaks at about 525 nm and carotenoid compounds absorb in a range of 475 nm to 525 nm, with varying peak heights and areas under the absorption curves.

It is envisaged that sprouting fodder grains benefit differently from other more well characterized mature plants. For example, we would consider that promoting absorption by anthocyanins in fodder sprouts would be pointless but encouraging carotenoids might be beneficial, especially at high light flux for chlorophyll because of a protective effect. Accordingly, a combination of 4 LEDs @ 665 nm, 2 LEDs @ 460 nm, and 1 each of 475, 500 and 525 nm may be advantageous. However, such a precisely calibrated array is expensive.

It is known in hydroponic horticulture that the use of mixed frequencies of LEDs, especially combinations of red and blue LEDs may promote growth on a “weight of growth to watt-hrs consumed” basis. In the present case the applicant has determined empirically that the combination of LEDs that is metabolically favourable and achievable at the cheapest cost is a combination of LEDs in 36-watt per meter strips comprising 1 blue (450 nm) LED for every 8 red (700 nm) LEDs. For platforms having a net mat growing area of 2.2 m² with the use of a suitable collimating reflector of 2.2 m length, the strips yield an average flux of 36 Wm⁻². This arrangement of red and blue LEDs has resulted in 10% more kilograms per watt-hour when compared to a control strip of 36 Wm⁻² delivered by all-white LEDs.

In environments having a diurnal average of about 18° C. and in fine weather, it has been determined that conditions inside the housing may be maintained within the range of 18 to 23° C. and 40 to 80% relative humidity (RH) by irrigation water temperature control alone, with a program of air exchange. For growing barley, for example, the optimal conditions of a temperature of about 23° C. at a humidity of between 40 and 80% RH are obtainable. In adverse external weather conditions, conditions inside the housing may be maintained within the range of 18 to 23° C. and 40 to 80%) relative humidity (RH) by irrigation water temperature control, with a program of air exchange, and temperature and/or relative humidity control supplemented by the use of heat pump means such as a reverse cycle air-conditioning unit.

The energy source for heating or cooling the water may be selected from heat pump means including reverse-cycle heat pump means, combustion heating such as solid or liquid fuel or gas, electric immersion heater mean or solar thermal means. The temperature control means may include tempering valve means, which enables the water supply to mix two sources, a hot water source and a cold water source, to deliver the controlled temperature irrigation water demanded to meet the programs of both temperature control and irrigation. The hot water source may comprise a solar thermal accumulator.

The temperature control means may be adapted to heat or cool the environment inside the housing.

The nature of the framing and platform assembly may be to act as a thermal buffer, wherein water passing through the seed or sprout may transfer heat to or extract heat from the assembly. The assembly thereafter functions as a heat sink or source for equilibration with its surroundings between irrigation cycles. This is facilitated by the slow passage of the irrigation water down the modest and preferred 4° slope. The slow passage also minimizes run-off the platform front lip to a floor drain.

The energy requirements of the apparatus of the present invention will most often comprise a thermal component and an electrical component. While the total energy requirement may be met by mains power, it is envisaged that economic operation in mains-connected areas may comprise a hybrid mains power/thermal solar system, whereby water supply heating is by the aforementioned solar thermal means (supplemented by an immersion heater when necessary) and electronic control, lighting and ventilation is done by electrical means powered by the mains supply.

In remote applications it is envisaged that the total energy needs be met by a solar thermal/solar PV hybrid system, whereby solar PV panels charge storage batteries and a solar thermal arrangement heats an insulated reservoir. The storage batteries may power LVDC equipment directly or power AC equipment via an inverter. In remote applications, it is expected that the solar PV and solar thermal elements will have significant reserve capacity. However, the system may be supplemented by a genset and/or external water heater if there are area constraints. The solar PV and/or solar thermal collectors may be mounted on the housing roof.

The irrigation, illumination and ventilation systems may have their respective control means integrated into a control assembly. The control assembly may include an environmental housing for one or both of a storage battery bank and an integrated electronic control panel, the relative warmth and high humidity of the growing environment being inimical for both systems. The electronic control panel may include a programmable logic controller for each of the irrigation, illumination and ventilation subsystems, or may include a multi-channel programmable logic controller. The electronic control panel may include one or more user interfaces providing for programming of subsystem parameters, isolation switching and/or manual override.

The user interface may include one or more of a membrane-protected key panel, with a touch or display only screen, a wired or wireless interface to a laptop or tablet computer and a dedicated use interface device.

The programmable controller is preferably a microprocessor based controller protected in an environmental mounting. The programmable controller may include an irrigation control function including digital or analogue control. It is known to provide analogue programmable logic controllers that are entirely pneumatic or hydraulic in their operation and are therefore independent of electricity supply.

However, the development of low voltage and inverter based electrical systems means that more cost effective electronic means such as a digital programmable logic controller may form the central element of the control means, even for remote installations. The irrigation control function may accordingly include a digital programmable logic controller.

The lighting control function of the programmable controller may take any form in general dictated by the choice of lighting. The lighting control may include a programmable timer function determining, according to a preselected program, a sequence of light and dark for a fodder production cycle or a part thereof. The lighting controller may comprise the same physical controller assembly as the irrigation controller. The program of lighting may be coordinated with the program of irrigation.

The programmable controller may deliver a time-variant program of temperature control, said temperature control preferably including controlling the temperature of said temperature control water.

The temperature control imposed by the programmable controller may comprise integration of the irrigation program with thermostatic control of the water supply. For example, the water supply may include one or more tanks at least one of which may be selectively heated. The heated tank may be provided with the usual self-regulation such as a float valve controlling filling of the tank. Typically, the temperature of a heated tank may be thermostatically regulated to between 20 and about 30° C. With the programmable controller relieved of active control of the heating element or other heating means, fine control of the temperature through control of the water temperature at the spray heads may be effected by a variable tempering valve controlled by the programmable controller.

In environments having a diurnal average of about 18° C., it has been determined that for a selected irrigation input, an irrigation water temperature at the sprinkler heads of 23° C. will maintain a reasonable growing temperature in the environment inside the housing.

The ventilation system control may be imposed by the programmable controller, such as programming a blower to perform an air exchange periodically, such as every two hours. Alternatively, the ventilation system may comprise an air exchange operation in response to a primary signal from a CO₂ detector.

According to a third aspect of the present invention there is provided a fodder growing method including:

providing an insulated housing having a draining floor portion and at least one loading and unloading opening, a plurality of vertically-spaced platforms supported in said housing, each platform being bounded by spaced end wall portions interconnected by a rear wall portion and an open front edge portion, the platforms being supported in a position inclined downward from the horizontal from said rear wall to said front edge, said front edges being accessible from said opening, an irrigation system including spray nozzles supported over each of said platforms and supplied with water, an illumination system supported over each of said platforms, a ventilation system including forced ventilation means, and a programmable controller selected to deliver a time-variant program of at least irrigation, lighting and temperature control;

distributing fodder sprout seeds to form a seed bed of selected thickness on said platforms;

operating said control means programmed to subject said seed bed to a program of irrigation from a water supply to said nozzles, lighting from said lighting means and temperature control for a period of time to germinate and grow the seed bed to a fodder mat.

According to a fourth aspect of the present invention there is provided a fodder growing method including:

providing an insulated housing having a draining floor portion and at least one loading and unloading opening, a plurality of vertically-spaced, polymer platforms supported in said housing, each platform being bounded by integral, spaced end wall portions interconnected by an integral rear wall portion and an open front edge portion, the polymer platforms being supported in a position inclined downward between 3° and 5° from the horizontal from said rear wall to said front edge, said front edges being accessible from said opening, a pass-through irrigation system including spray nozzles supported over each of said platforms and supplied with temperature controlled water, an illumination system including LED equipped lighting assembly supported over each of said platforms, a ventilation system including forced ventilation means, and a programmable controller selected to deliver a time-variant program of at least irrigation, lighting and temperature control, said temperature control including controlling the temperature of said temperature controlled water;

distributing fodder sprout seeds to form a seed bed of selected thickness on said platforms;

operating said control means programmed to subject said seed bed to a program of irrigation from a water supply to said nozzles, lighting from said lighting means and temperature control for a period of time to germinate and grow the seed bed to a fodder mat.

The vertically-spaced platforms, insulated housing, platform supports, spray nozzles and lighting means may be as per the description above.

The fodder sprout seed may be distributed on the platforms by any suitable means, such as by a straight edged paddle or gauge rake with a pair of spaced prongs to contact the platform and define an opening bounded by the platform, prongs and straight edge, the opening corresponding to a selected profile of the seed bed.

Alternatively, the seed bed may be loaded and spread by a seed loader as described above. The density of nutritious feed is increased, and the economies of production are accordingly increased, by increasing the seed loading on the platform. The maximum seed bed depth is determined by the ability of the bed to sprout without causing a high percentage of failures to germinate, or a high percentage of germinated spouts dying, such as from surfeit of metabolic products. Management of sprouting parameters including seed bed depth all contribute in reducing rot and other fruits of contamination. For example, high germination rates with excessive sprout death is associated with excessive free sugars such as maltose, with attendant increased risk of fungal, bacterial and protozoan proliferation.

The prior art methods referred to herein are capable of fodder seeding rates of up to 4.5 kgm⁻². It has been found that by management of defined parameters, seeding rates using methods and apparatus of the present invention may be at least 8 kgm⁻².

Fodder growing seeds for use in the present invention may be pre-treated. For example, the seeds may be treated to reduce the prevalence of spores or bacteria, thus statistically reducing the likelihood of contamination. The seed may be pre-treated with a wetting agent to promote wetting out of the seed bed whilst encouraging free drainage.

The fodder growing unit of the present invention may be used to sprout a variety of grains and seeds for livestock and human consumption including barley, alfalfa, sunflowers, mung beans, wheatgrass, fenugreek, onion, snow peas, and the like.

There is a circumstance of tertiary complexity governing seed beds of the type and density envisaged for use in the present invention. Seed bed retention from physical slumping implies platforms of about 4° slope as discussed above. The seeds themselves tend to have a hydrophobic coat. Whilst this may be stripped by for example pre-washing with sodium hypochlorite solution, there are mortality and chemical contamination issues associated with this method. The hydrophobic seeds, when in the seed bed, wet out very unevenly. Some patches are suitably wet, others are essentially saturated by capillary action, and others are dry to the point of not germinating. The monolayer against the platform itself tends not to drain at all without hydrostatic head from above in the seed bed, being maintained at the 4° slope by capillary action.

It has been surprisingly determined that controlled dosing of the water supply with a suitable food-grade non-ionic surfactant essentially solves the complex interplay of factors and promotes an even wetting out of the seed bed, and including free drainage of the monolayer adjacent the platform growing surface. This wetting out principle, combined with a platform drainage slope of about 4° and selection of a watering regime closely controlled by a PLC, may result in water consumption as low as 2 litres per kilo of finished fodder sprouts. By this means, the untreated seed may substantially address the deleterious effects of uneven germination and growth, rotting from the bottom up and the like, and enables the growing of fodder mats on seeding rates of more than 8 kgm⁻².

The food-grade non-ionic surfactant may be selected from long-chain alcohols such as cetyl alcohol, stearyl alcohol, cetostearyl alcohol and oleyl alcohol, Polyoxyethylene glycol alkyl ethers (CH₃—(CH₂)₁₀₋₁₆—(O—C₂H₄)₁₋₂₅—OH), Octaethylene glycol monododecyl ether, Pentaethylene glycol monododecyl ether, Polyoxypropylene glycol alkyl ethers (CH₃—(CH₂)₁₀₋₁₆—(O—C₃H₆)₁₋₂₅—O), Glucoside alkyl ethers (CH₃—(CH₂)₁₀₋₁₆—(O-Glucoside)₁₋₃—OH), Decyl glucoside, Lauryl glucoside, Octyl glucoside, Polyoxyethylene glycol octylphenol ethers (C₈H₁₇—(C₆H₄)—(O—C₂H₄)₁₋₂₅—OH such as Triton X-100, Polyoxyethylene glycol alkylphenol ethers (C₉H₁₉—(C₆H₄)—(O—C₂H₄)₁₋₂₅—OH, Nonoxynol-9), Glycerol alkyl esters such as Glyceryl laurate, Polyoxyethylene glycol sorbitan alkyl esters (e.g. Polysorbate, Tween 60, Tween 80), Sorbitan alkyl esters (e.g. Spans), Cocamide MEA, cocamide DEA, Dodecyldimethylamine oxide, Block copolymers of polyethylene glycol and polypropylene glycol (Poloxamers), and Polyethoxylated tallow amine (POEA).

The fodder growing system is not hydroponic; the system is essentially nutrient free to curb microbial proliferation. However, in addition to surfactant, the water may be dosed with enhancers such as root stimulant.

The additives above may be omitted in whole or part by the act of pre-soaking the seed before applying it in a seed bed to the platforms. For example the seed may be pre-soaked in essentially sterile water containing one of more of surfactant and root stimulant or the like. Typically, grain for sprouting may be pre-soaked for 6 to 12 hours before draining and setting up the seed bed on the platforms.

It has been surprisingly determined that a better grade of feed is provided where the starch/sugar conversion part of germination is not driven to completion. This can be achieved in a 5 day cycle to produce fodder that has at least a portion of seed starch remaining. In this process, pre-soaking of the seed is an important part.

The method or the present invention may include supplementary treatment means. For example, a further antimicrobial effect may be had from associating an O₃ (ozone) generator with the housing air or water supply. Ozone is a corrosive and irritating gas. As the interior of the housing is a workplace, it is desirable to maintain any ozone treatment at a level where the ozone content of the air is less than permissible exposure limit of 0.1 μmol/mol or 100 ppb (parts per billion), calculated as an 8 hour time weighted average. Higher concentrations may be used with a program of air purging before entry. At all times the ozone concentration is preferably below the concentration immediately dangerous to life and health of 5 μmol/mol.

Ozonation may be done by way of ozone generation in conjunction with the water supply. The water supply may be associated with, for example, a vacuum-ultraviolet (VUV) ozone generator. VUV ozone generators, unlike corona discharge generators, do not produce harmful nitrogen-oxide by-products and also unlike corona discharge systems, VUV ozone generators work extremely well in humid air environments. Alternatively, electrolytic ozone generation (EOG), which splits water molecules into H₂, O₂, and O₃, may be used, provided that the hydrogen gas is safely dispersed. Ozone is only sparingly soluble in water. Accordingly ozonation of the water supply is safe.

It has been surprisingly determined that ozonation of the water results in faster germination. It is surmised that ozone assists in stripping the natural hydrophobic surface from the dry seed. It may also be that decomposition of the ozone yields oxygen available to promote the germination process which, as described above, is an oxygen dependent respiratory process.

Ozone may also be injected into the incoming air of the room. This may assist to keep the room clean and substantially sterile.

The watering program may take any suitable form consistent with sprouting of the seeds. Since the process is not hydroponic, there is no need to recirculate to conserve nutrients. In fact it is preferred that there is no recirculation to reduce risk of contamination. The watering program may be selected whereby there is a minimum of drainage over the front edge of the platforms. Such drainage as necessarily must occur may pass to a trough formed in the floor and thence to a floor drain, be collected by a lip drain below the free edge for conveyance to the platforms ends and thence to drain, or the like.

The details of the watering program are determined empirically depending on the nature of the seed bed. However as a generally applicable rule it has been determined that the watering program be characterized by medium application rates for initial wetting out, low rates for initial cotyledon break out, medium rate to initial photosynthetic transition, and high rate for the photosynthetic growth phase. In this context the rates of application may be achieved by modifying either the time of operation of the nozzles or by the rate of flow through the nozzles. For example, the “low application rate” may comprise frequent misting applications for the initial 48 hours of a 6-day growing cycle, whereas the medium application rate may be less frequent but more akin to “watering”.

It has been empirically determined that an initial period of “wetting out” may involve running the irrigation nozzles for 30 seconds per hour on the first day, in frequent applications of short duration. This minimizes run-off while wetting out, at a time of low water uptake. On the second day, with metabolic processes changing from quiescent to active, the watering regime may be less frequent but of longer duration, while delivering the same rate, that is 30 seconds per hour. Day three may be expected to be the peak of water consumption as the sprouts build enough hydrated mass to support photosynthesis under constant light. For example the rate may be increased by a third by increasing the duration of spraying (that is, a net rate of 40 sec/hr). Days 4 and 5 may represent a “steady state” of photosynthetic growth under constant light, with a water requirement throttled back to a nozzle-on time of, for example, 30 seconds per hour. The developing mat is now at a stage where the rate can be delivered at say 30 second duration sprays once every hour. The sixth day is a “hardening” day with a further reduced watering requirement of say 30 second duration sprays once every hour and a half. Such a regime will cater for growth of mats from seed beds laid at more than 8 kgm² while registering a water consumption of less than 2 litres per kg of feed produced.

The control of the lighting may include control of the periodicity of the lighting and the intensity of the lighting. In the case of the preferred LED lighting, the control means preferably switches the lighting on and off. During the germination phase, the dynamics of plant growth are governed more by warmth and moisture than light. It is preferred to economize the program by switching on the illumination on, for example, Day 3 of the above irrigation program. Thereafter, the illumination is preferably constant from the third day to the sixth day.

Once grown, typically 6 days in the case of fodder, the harvested plants are removed from the platform, either by hand or machine, the platforms are washed and cleaned, and the process re-initiates. At a seeding rate of greater than 8 kgm⁻² it follows that the grown fodder mat will exceed the OH&S limits for manual handling. However, the preferred ABS platforms are moulded with dividers to reduce the individual mat component weights. Nonetheless, the corridor between adjacent rows of platforms may form a passage in which a wheeled trolley may pass, the fodder mat being manually dragged down-slope off the platform to fall on to the trolley under gravity.

According to a fifth aspect of the present invention, there is provided a fodder growing system comprising:

a transportable insulated housing having:

a floor, a roof, a pair of spaced side walls extending between the roof and floor, and a pair of spaced end walls extending between the roof, floor and side walls, wherein the side walls are of greater length than the end walls;

a fodder growing compartment located within the housing;

at least one closable opening in at least one of the side walls for accessing the compartment; and

a plurality of fodder-growth surfaces supported within the compartment, each surface being adapted to support and grow fodder seeds so as to form a fodder mat, wherein each said surface has a fodder mat unloading end accessible from outside the compartment by way of the at least one closable opening, and each said surface is inclined relative to the horizontal such that irrigation water can drain downwardly over the unloading end and the fodder mat can be removed from the surface by way of the unloading end.

The housing may be of any suitable size, shape and construction, and may be made of any suitable material or materials, such as metal, timber and/or plastics material. The housing may be as described for other aspects of the present invention. In some embodiments the housing may be in the form of a container. In some embodiments the housing may be in the general form of an insulated shipping container such as a standard or high-cube shipping container. Such a container typically has a panel floor, panel roof, panel sidewalls, panel end walls as well as one or more panel doors for closing one or more openings in an end wall. One or more of these panels and/or doors may be insulated. However, the housing of the instant invention according to the fifth aspect differs from a standard shipping container in that the at least one closable opening is located in at least one of the side walls, rather than in an end wall.

The at least one closable opening may be of any suitable size, shape and construction, and be made of any suitable material or materials. The at least one closable opening may be provided in part by an opening in the side wall. The at least one closable opening may be provided in part by a closure that may be moved between open and closed positions relative to the opening in the side wall. Preferably, the at least one closure can seal the opening when in the closed position. The at least one closable opening can be the same as the loading and unloading opening as described for an earlier aspect of the present invention.

The opening may be of any suitable shape and size. Likewise, the closure may be of any suitable shape, size and construction but such that it can close the opening. Typically the closure will be in the form of a door, window, panel, shutter or flap. If in the form of a door, window, panel, shutter or flap, the door, window, panel, shutter or flap may be hinged to the side wall or other part of the housing so as to pivot about a vertical axis between the open and closed positions. Alternatively, the door, window, panel, shutter or flap may be hinged to the side wall or other part of the housing so as to pivot about a horizontal axis between the open and closed positions. If in the form of a roller door or shutter, the roller door or shutter may be mounted to a part of the housing (e.g. roof or side wall) such that the roller door or shutter may be raised and lowered (or otherwise moved) between the open and closed positions. If in the form of a sliding door, window, panel or shutter, the sliding door, window, panel or shutter may be slid substantially parallel with the side wall between the open and closed positions. If in the form of a fabric flap, the flap may be mounted to a part of the housing (e.g. roof or side wall) such that the flap may be moved between the open and closed positions.

As for conventional types of closable openings, the closable opening: may have a grip/handle associated with the closure; may have a seal for sealing tight the opening; may include a lock or latch for locking or otherwise holding the closure in the open and/or closed position; may include one or more (pneumatic/gas) struts for holding the closure in the open and/or closed position; and/or may allow transmission of natural light into the compartment when in the closed position.

Preferably, the housing has at least one closable opening in each of the side walls for accessing the compartment and more particularly for accessing the unloading end of one or more supports. Preferably the closable opening provides access to all unloading ends of all supports. More preferably, each side wall has a plurality of closable openings. In some embodiments, each side wall can have a single closable opening, preferably in the form of a door. In some embodiments, one or each side wall can have 2 closable openings, preferably each in the form of a door. In some embodiments, one or each side wall can have 3 closable openings, preferably each in the form of a door. In some embodiments, one or each side wall can have 4 closable openings, preferably each in the form of a door. In some embodiments, one or each side wall can have 5 closable openings, preferably each in the form of a door. In some embodiments, one side wall can have 3 openings and the other side wall can have four openings, preferably each in the form of a door. For clarity, any one opening can be closed or sealed using a single door or double door arrangement.

The fodder growing compartment may be of any suitable shape and size.

Preferably the compartment is shaped and sized so as to allow the growth of as much fodder seed as possible—preferably substantially an entire inner space of the housing, although this need not be the case. The fodder growing compartment may be divided into sub compartments. The fodder growing compartment may be as described for other aspects of the invention.

The fodder growing system may have one or more other compartments, such as a compartment for storing equipment (referred to elsewhere in this specification as an equipment space or equipment enclosure).

The plurality of fodder-growth surfaces supported within the compartment may be of any suitable size, shape and construction, and may be made of any suitable material or materials. Each surface may be constructed of plastics material, composites, polymers, metal, glass, fibreglass, ceramics or rubber, for example. In some embodiments, as described for polymer platforms in other aspects of the invention, polymer surfaces may comprise a moulded thermoset, two-pack or thermoplastic polymer or polymer composite material. The polymer surfaces may be vacuum or die formed. Examples of thermo vacuum-formable sheet thermoplastic for use in forming the polymer surfaces are ABS, HDPE or PP. Examples of vacuum-formable thermoset or two pack prepregs include epoxy, polyester and vinyl ester sheet moulding compounds.

In preferred embodiments each surface extends substantially across the entire compartment, substantially from one housing side wall to the other, so as to maximise fodder growth area (as described for other aspects of the invention, but referred to elsewhere as a platform). The unloading end of each surface (referred to elsewhere as an open front edge portion) may extend substantially parallel with a side wall or opening in the side wall. A growth area of each surface on which fodder seed is actually grown may be substantially flat/planar. The growth area of each surface may be provided by a substantially planar sheet.

Each surface may have a raised periphery or edge extending from the unloading end and around the growth area so as to contain fodder seed within the growth area so as to form a suitable fodder mat (essentially as described elsewhere in this specification).

Each surface may be provided by a platform, shelf, tray or like structure supported within the compartment. The platform, shelf or tray may have a raised periphery or edge extending from the unloading end and around the growth area. Depending on the length and breadth of the fodder mat to be grown, the platform, shelf or tray may have at least one dividing wall, baffle or strengthening rib extending substantially perpendicularly of the unloading end and separating one fodder growth area from another. Such a dividing wall, baffle or rib may not prevent drainage of water from the platform, shelf or tray, nor obstruct removal of a fodder mat from the unloading end. The platform, shelf or tray may have 2 or more dividing walls, baffles or ribs spaced from each other so as to enable the production of fodder mats of suitable size and weight.

In some embodiments, the surface may have 2 opposed unloading ends, in which case the surface may resemble an inverted V shape, having a central peak/apical region. With this arrangement a single surface can be used to grow separate fodder mats, with each mat being unloaded from a particular side (side wall) of the housing.

The surfaces, platforms, shelves or trays may be supported above and/or along side one another, provided that the spacing allows for clearance for fodder growth, adequate irrigation and adequate lighting. In some embodiments 2, 3, 4, 5, 6, 7, 8, 9, 10 or more surfaces, platforms, shelves or trays may be supported above one another in a vertical stack within the compartment. In some embodiments, 2, 3, 4, 5, 6, 7, 8, 9, 10 or more vertical stacks may be positioned along side one another within the compartment.

The plurality of fodder-growth surfaces, platforms, shelves or trays may be supported within the compartment/housing in any suitable way. For example, the growth system may include a support structure such as a rack, shelving system, stand or frame. For example, the growth system may include the metal frame assembly or metal framing arrangement as described for other aspects of the invention. The support structure may be connected to one or more walls, roof and/or floor of the housing, or the support structure may be free standing. The plurality of fodder-growth surfaces, platforms, shelves or trays may be fixedly connected to the support structure or connected to the support structure for movement relative thereto. For example, the surface, platform, shelf or tray may be connected to the support structure by way of a rail or roller system, allowing movement and extension of the unloading end through the closable opening and externally of the compartment. This may assist with initial seeding, growth inspection and/or unloading of the fodder mat, as well as cleaning and maintenance of the surfaces.

Each said surface may be inclined relative to the horizontal in any suitable way. In some embodiments the housing itself may be supported at an incline relative to the horizontal such that each support is inclined relative to the horizontal. In some embodiments the housing may be supported in a level manner yet each said surface may be supported within the compartment at the desired degree of inclination.

Each surface may be downwardly inclined at any suitable angle relative to the horizontal, so as to enable drainage of water downwardly along a growth area of the surface. For example, the angle of inclination may be approximately 0.5°, 1°, 1.5°, 2°, 2.5°, 3°, 3.5°, 4°, 4.5°, 5°, 5.5°, 6° or even greater. In some embodiments the surfaces may be supported in a position inclined downward between about 2° and about 6° from the horizontal.

The housing is preferably supported on a concrete slab but may be supported on blocks or the like.

The housing may have a drainage system. In some embodiments the floor of the housing may slope to a drainage channel or other waste outlet, for removal of waste water from within the compartment.

The fodder growing system may include one or more features as described for other aspects of the invention, including, but not limited to, an irrigation system, an illumination system, a ventilation system and a programmable controller.

Another aspect of the present invention relates to seed loader. The seed loader may be used in connection with one or more other aspects of the present invention.

According to a sixth aspect of the present invention, there is provided a seed loader comprising:

an elongate tray having a channel for holding seed, wherein the tray has an open end at one end of the channel, and a closed end at an opposed end of the channel;

a longitudinal axis extending within the channel; and

a handle extending from the closed end, enabling the elongate tray to be rotated about the longitudinal axis, so as to discharge the seed from within the channel.

According to a seventh aspect of the present invention, there is provided a method of forming a fodder seed bed comprising the steps of:

charging the seed loader as defined according to the sixth aspect with fodder seed; and

discharging the seed onto a fodder growth surface so as to form a fodder seed bed.

The elongate tray may be of any suitable size, shape, length and construction, and can be made of any suitable material or materials. For example, the tray may be made of metal or plastics material.

The tray/channel may be of any suitable cross section for holding the seed. For example, the tray/channel may have an arcuate, C-shaped, V-shaped or U-shaped cross section.

The tray/channel cross sectional shape may determine the shape of the open end. For example, if the tray/channel is of arcuate cross-section then the open end may be of arcuate shape. The open end may be used to fill/charge the channel with seed. The open end may be used to shape the seed bed after seed discharge, when dragging the seed loader along the fodder growth surface.

The closed end may be walled or otherwise closed or sealed. The tray/channel cross sectional shape may determine the shape of the closed end. For example, if the tray/channel is of arcuate cross-section then the closed end may be an arcuate wall.

The handle may be of any suitable size, shape and construction, and may be made of any suitable material or materials. The handle may be of unitary construction with the tray. For example, the handle may extend from the closed end such that a person's fingers may grip the handle and extend between the handle and the closed end.

The seed loader may include friction edging adjacent the open end, for when dragging the loader along the fodder growth surface and shaping the seed bed. Opposed elongate edges of the tray may support short pieces of low friction plastic edging at the open end.

Preferred embodiments of the invention are described in the following numbered paragraphs.

1. A fodder growing system including:

an insulated housing having a draining floor portion and at least one loading and unloading opening;

a plurality of vertically-spaced, polymer platforms supported in said housing, each platform being bounded by integral, spaced end wall portions interconnected by an integral rear wall portion and an open front edge portion, the polymer platforms being supported in a position inclined downward between 3° and about 6° from the horizontal from said rear wall to said front edge;

a pass-through irrigation system including spray nozzles supported over each of said platforms and supplied with temperature controlled water;

an illumination system including LED equipped lighting assembly supported over each of said platforms;

a ventilation system including forced ventilation means;

a programmable controller selected to deliver a time-variant program of at least irrigation and lighting; and

temperature control means controlling the temperature within said housing by controlling the temperature of said water supply.

2. A fodder growing system according to paragraph 1, wherein the housing comprises a building having a floor, two opposed end walls and two opposed side walls interconnecting the end walls, the side and end walls being formed of insulated panels, an insulated-panel top wall comprising both roof and ceiling of the building, and a pair of doors selectively closing respective opposed openings in the end walls.

3. A fodder growing system according to paragraph 2, wherein the opposed openings define a passage through the building.

4. A fodder growing system according to paragraph 3, wherein the passage is defined within the housing by platforms on both sides of the passage.

5. A fodder growing system according to paragraph 1, wherein the housing includes the general plan of an ISO container selected from a standard or high-cube shipping container.

6. A fodder growing system according to paragraph 5, wherein the at least one loading and unloading opening comprises opening side panels forming part of side walls of the housing.

7. A fodder growing system according to paragraph 5, wherein the floor of the housing slopes to a drain.

8. A fodder growing system according to paragraph 5, wherein the programmable controller is isolated from the interior of the housing in a control locker formed by a false end wall set in from one end of the housing to form a recess.

9. A fodder growing system according to paragraph 1, wherein the ventilation system is operable to effect a fresh air change of about two housing volumes per day.

10. A fodder growing system according to paragraph 9, wherein the ventilation means includes air conditioning means.

11. A fodder growing system according to paragraph 1, wherein the platforms comprise a metal frame assembly supporting a plurality of platform members.

12. A fodder growing system according to paragraph 1, wherein the platforms each have one or more dividing walls extending from the rear wall portion toward the front edge.

13. A fodder growing system according to paragraph 12, wherein the polymer platforms each comprise a moulded ABS polymer.

14. A fodder growing system according to paragraph 13, wherein the dividing wall portions are thermoformed as a flattened re-entrant.

15. A fodder growing system according to paragraph 1, wherein the platforms are supported on a metal frame assembly comprising substantially vertical support members located adjacent selected end wall portions and cooperating with at least two spaced platform support bars interconnecting the vertical support members.

16. A fodder growing system according to paragraph 15, wherein the metal frame assembly comprises a thermal mass formed of aluminium box section and comprising uprights supporting stringers supporting or suspending the platform members.

17. A fodder growing system according to paragraph 1, wherein the inclination is about 4°.

18. A fodder growing system according to paragraph 12, wherein the dividing walls are selected as to placement to control the size of the fodder biscuit.

19. A fodder growing system according to paragraph 1, wherein the irrigation system includes a water supply selected from one or more of water storage means and a reticulated supply.

20. A fodder growing system according to paragraph 19, wherein the water supply includes water collection means utilizing the roof of the housing as a water collection surface.

21. A fodder growing system according to paragraph 19, wherein the programmable controller operates valves in accordance with a selected program to selectively deliver irrigation water to spray nozzles.

22. A fodder growing system according to paragraph 21, wherein the nozzles are selected from low impact nozzles selected to deliver one or more of a spray component, a drip component and a mist component.

23. A fodder growing system according to paragraph 18, wherein the irrigation system further includes treatment means for the irrigation water.

24. A fodder growing system according to paragraph 23, wherein the treatment means comprises one or more of ozonation of the water supply, dosing with a food grade, non-ionic surfactant, and dosing with a root stimulant.

25. A fodder growing system according to paragraph 1, wherein the LED equipped lighting assemblies comprise 4 parts LEDs @ 665 nm, 2 parts LEDs @ 460 nm, and 1 each parts of 475, 500 and 525 nm.

26. A fodder growing system according to paragraph 1, wherein the LED equipped lighting assemblies comprise a combination of LEDs in 36-watt per meter strips comprising 1 blue (450 nm) LED for every 8 red (700 nm) LEDs.

27. A fodder growing system according to paragraph 1, wherein the programmable controller includes a programmable timer function determining, according to a preselected program, a sequence of light and dark for a fodder production cycle or a part thereof.

28. A fodder growing system according to paragraph 1, wherein the temperature control means controls the temperature of the irrigation water at the spray nozzles to be from about 10° C. to about 40° C.

29. A fodder growing system according to paragraph 28, wherein the irrigation water temperature at the spray nozzles is controlled to be about 23° C.

30. A fodder growing system according to paragraph 28, wherein the conditions inside the housing are maintained within the range of 18 to 23° C. and 40 to 80% relative humidity (RH) by irrigation water temperature control alone, with a program of air exchange.

31. A fodder growing system according to paragraph 1, wherein the programmable controller is a microprocessor based controller.

32. A fodder growing system according to paragraph 31, wherein the microprocessor based controller a digital programmable logic controller.

33. A fodder growing system according to paragraph 31, wherein the temperature control is imposed by the programmable controller and comprises integration of the irrigation program with thermostatic control of the water supply.

34. A fodder growing system according to paragraph 31, wherein the ventilation system control is imposed by the programmable controller.

35. A fodder growing method including:

providing an insulated housing having a draining floor portion and at least one loading and unloading opening, a plurality of vertically-spaced, polymer platforms supported in said housing, each platform being bounded by integral, spaced end wall portions interconnected by an integral rear wall portion and an open front edge portion, the polymer platforms being supported in a position inclined downward between 3° and 5° from the horizontal from said rear wall to said front edge, said front edges being accessible from said opening, a pass-through irrigation system including spray nozzles supported over each of said platforms and supplied with temperature controlled water, an illumination system including LED equipped lighting assembly supported over each of said platforms, a ventilation system including forced ventilation means, and a programmable controller selected to deliver a time-variant program of at least irrigation, lighting and temperature control, said temperature control including controlling the temperature of said temperature controlled water distributing fodder sprout seeds to form a seed bed of selected thickness on said platforms;

operating said control means programmed to subject said seed bed to a program of irrigation from a water supply to said nozzles, lighting from said lighting means and temperature control for a period of time to germinate and grow the seed bed to a fodder mat.

36. A fodder growing method according to paragraph 35, wherein the seed bed is formed by a straight edged paddle or gauge rake with a pair of spaced prongs to contact the platform and define an opening bounded by the platform, prongs and straight edge, the opening corresponding to a selected profile of the seed bed.

37. A fodder growing method according to paragraph 35, wherein the platforms include dividing walls between the rear wall and the front edge and the seed bed is relieved or shallower at the sides adjacent at least the dividing walls.

38. A fodder growing method according to paragraph 37, wherein the seed bed is loaded via a seed bed loader comprising an elongate tray of arcuate cross section, the width of the elongate tray being less than the spaces between the side walls and dividing walls, the elongate tray having one open arcuate end and one walled arcuate end, the walled arcuate end bearing a handle.

39. A fodder growing method according to paragraph 35, wherein the seeding rate is selected to be at least 8 kgm⁻².

40. A fodder growing method according to paragraph 35, wherein the fodder growing seeds are pre-treated to reduce the prevalence of spores or bacteria.

41. A fodder growing method according to paragraph 35, wherein the fodder growing seed are selected from one or more of barley, alfalfa, sunflowers, mung beans, wheatgrass, fenugreek, onion, snow peas, and the like.

42. A fodder growing method according to paragraph 35, wherein the water supply is dosed with one or more of a food-grade non-ionic surfactant, a root stimulant, and ozone, said inclination downward from said rear edge to said front edge forms a drainage slope of about 4° and said program of irrigation is controlled by a PLC to about 2 litres per kilogram of finished fodder sprouts.

43. A fodder growing method according to paragraph 42, wherein the food-grade non-ionic surfactant is selected from long-chain alcohols such as cetyl alcohol, stearyl alcohol, cetostearyl alcohol and oleyl alcohol, Polyoxyethylene glycol alkyl ethers (CH₃—(CH₂)₁₀₋₁₆—(O—C₂H₄)₁₋₂₅—OH), Octaethylene glycol monododecyl ether, Pentaethylene glycol monododecyl ether, Polyoxypropylene glycol alkyl ethers (CH₃—(CH₂)₁₀₋₁₆—(O—C₃H₆)₁₋₂₅—O), Glucoside alkyl ethers (CH₃—(CH₂)₁₀₋₁₆—(O-Glucoside)₁₋₃—OH), Decyl glucoside, Lauryl glucoside, Octyl glucoside, Polyoxyethylene glycol octylphenol ethers (C₈H₁₇—(C₆H₄)—(O—C₂H₄)₁₋₂₅—OH such as Triton X-100, Polyoxyethylene glycol alkylphenol ethers (C₉H₁₉—(C₆H₄)—(O—C₂H₄)₁₋₂₅—OH, Nonoxynol-9), Glycerol alkyl esters such as Glyceryl laurate, Polyoxyethylene glycol sorbitan alkyl esters (e.g. Polysorbate, Tween 60, Tween 80), Sorbitan alkyl esters (e.g. Spans), Cocamide MEA, cocamide DEA, Dodecyldimethylamine oxide, Block copolymers of polyethylene glycol and polypropylene glycol (Poloxamers), and Polyethoxylated tallow amine (POEA).

44. A fodder growing method according to paragraph 43, wherein the food-grade non-ionic surfactant is Tween 60.

45. A fodder growing method according to paragraph 35, including treating the air within the housing with ozone at a level where the ozone content of the air is less than 0.1 μmol/mol or 100 ppb (parts per billion), calculated as an 8 hour time weighted average.

46. A fodder growing method according to paragraph 35, wherein the program of irrigation comprises a six-day process of:

(i) an initial period of “wetting out” by running the irrigation nozzles for 30 seconds per hour on a first day, in frequent applications of short duration;

(ii) a second day regime of less frequent but of longer duration, delivering the 30 seconds per hour at 15 second duration at a 30 minute intervals;

(iii) a third day regime at a net rate of 40 sec/hr, comprising 20 second duration and 30 minute intervals;

(iv) A fourth and fifth day regime of 30 seconds per hour; and

(v) a sixth day regime of 30 second duration sprays once every hour and a half

47. A fodder growing method according to paragraph 46, wherein the program of illumination operation of a combination of LEDs in 36-watt per meter strips comprising 1 blue (450 nm) LED for every 8 red (700 nm) LEDs, wherein the growing cycle is a 6-day cycle and the illumination is constant from the third day to the sixth day.

48. A fodder growing method according to paragraph 35, wherein the program of irrigation comprises a five-day process of:

(i) soaking seed for from 6 to 12 hours;

(ii) running the irrigation nozzles for 30 seconds per hour on a first day, in frequent applications of short duration;

(iii) a second day regime of less frequent but of longer duration, delivering the 30 seconds per hour at 15 second duration at a 30 minute intervals;

(iv) a third day regime at a net rate of 40 sec/hr, comprising 20 second duration and 30 minute intervals;

(v) a fourth and fifth day regime of 30 seconds per hour; and

(vi) harvesting the fodder.

49. A fodder growing method according to paragraph 46, wherein the program of illumination operation of a combination of LEDs in 36-watt per meter strips comprising blue (450 nm) LED for every 8 red (700 nm) LEDs, wherein the illumination is one hour one hour off, from the third day to the fifth day.

Yet further preferred embodiments of the invention are described in the following numbered paragraphs.

1. A fodder growing system including:

an insulated housing having a draining floor portion and at least one loading and unloading opening;

a plurality of vertically-spaced platforms supported in said housing, each platform being bounded by spaced end wall portions interconnected by a rear wall portion and an open front edge portion, the platforms being supported in a position inclined downwardly from said rear wall to said front edge, said front edges being accessible from said opening;

an irrigation system including spray nozzles supported over each of said platforms and supplied with water;

an illumination system supported over each of said platforms;

a ventilation system including forced ventilation means; and

a programmable controller selected to deliver a time-variant program of at least irrigation, lighting and temperature control.

2. The fodder growing system of paragraph 1, wherein the housing resembles a transportable shipping container.

3. A fodder growing system including:

a transportable insulated housing having:

a floor, a roof, a pair of spaced side walls extending between the roof and floor, and a pair of spaced end walls extending between the roof, floor and side walls, wherein the side walls are of greater length than the end walls;

a fodder growing compartment located within the housing;

at least one closable opening in at least one of the side walls for accessing the compartment; and

a plurality of fodder-growth surfaces supported within the compartment, each surface being adapted to support and grow fodder seeds so as to form a fodder mat, wherein each said surface has a fodder mat unloading end accessible from outside the compartment by way of the at least one closable opening, and each said surface is inclined relative to the horizontal such that irrigation water can drain downwardly over the unloading end and the fodder mat can be removed from the surface by way of the unloading end.

4. The fodder growing system of paragraph 3, wherein the housing resembles a transportable shipping container.

5. The fodder growing system of paragraph 3, wherein the at least one closable opening is provided by an opening in a said side wall and a closure that is movable between open and closed positions relative to the opening in said side wall.

6. The fodder growing system of paragraph 5, wherein each said side wall has a plurality of said at least one closable opening comprising a door and doorway.

7. The fodder growing system of paragraph 3, wherein each said surface extends substantially across the entire compartment from one said side wall to the other.

8. The fodder growing system of paragraph 3, wherein the plurality of surfaces are supported above one another.

9. The fodder growing system of paragraph 8, wherein the plurality of surfaces are supported along side one another.

10. The fodder growing system of paragraph 3, further including a support structure for supporting the plurality of surfaces, said support structure being selected from the group consisting of a rack, shelving system, stand and frame.

11. The fodder growing system of paragraph 3, wherein the housing includes a drainage system for removal of waste water from within the compartment.

12. A seed loader comprising:

an elongate tray having a channel for holding seed, wherein the tray has an open end at one end of the channel, and a closed end at an opposed end of the channel;

a longitudinal axis extending within the channel; and

a handle extending from the closed end, enabling the elongate tray to be rotated about the longitudinal axis, so as to discharge the seed from within the channel.

13. The seed loader of paragraph 12, wherein the tray/channel has an arcuate cross section.

14. The seed loader of paragraph 12, further including a friction edging adjacent the open end.

15. The fodder growing system of paragraph 1, wherein the housing comprises a building having a floor, two opposed end walls and two opposed side walls interconnecting the end walls, the side and end walls being formed of insulated panels, an insulated-panel top wall comprising both roof and ceiling of the building, and a pair of doors selectively closing respective opposed openings in the end walls.

### BRIEF DESCRIPTION OF THE DRAWINGS

FIG. 1 is a partially cut-away perspective view of the embodiment;

FIG. 2 is an internal plan view of the embodiment;

FIG. 3 is an internal side elevation of the embodiment;

FIG. 4 is an internal end elevation of the embodiment;

FIG. 5 is a detail side view of a metal framing system for use in the embodiment;

FIG. 6 is a detail end view of the metal framing system of FIG. 5;

FIG. 7 is a detail front view of the metal framing system of FIGS. 5 and 6;

FIG. 8 is a detail view of a moulded platform for use in the embodiment of the invention;

FIG. 9 is a top, left isometric view of a container-form alternative embodiment of the present invention, with doors removed;

FIG. 10 is an end view of the apparatus of FIG. 9;

FIG. 11 is a top plan view (with the container top removed for clarity) of the apparatus of FIG. 9;

FIG. 12 is a detail internal end view of the apparatus of FIG. 9;

FIG. 13 is a top, right isometric view of the apparatus of FIG. 9, with doors installed;

FIG. 14 is an exploded isometric view of the apparatus of FIG. 13;

FIG. 15 is a detail plan view of the apparatus of FIG. 13;

FIG. 16 is a detail rear view of the apparatus of FIG. 13;

FIG. 17 is a detail end view of the apparatus of FIG. 13;

FIG. 18 is the Detail A of FIG. 17;

FIG. 19 is the irrigation system of the embodiment of FIG. 13;

FIG. 20 is the Detail B of FIG. 19;

FIG. 21 is a top isometric view of a platform for use in the embodiment of FIG. 13;

FIG. 22 is a ventilation assembly for use with the apparatus of FIG. 13;

FIG. 23 is a top isometric view of a seed loader for use with the apparatus of FIG. 13;

FIG. 24 is a side elevation view of part of a side wall of a transportable insulated housing of a fodder growing system, like that shown in FIG. 14, according to another embodiment of the invention;

FIG. 25 is a side elevation view of part of another side wall of the transportable insulated housing shown in FIG. 24;

FIG. 26 is a detailed top plan view of the transportable insulated housing shown in FIG. 24, further showing a plurality of fodder-growth surfaces connected to a support structure; and

FIG. 27 is a detailed end view of the transportable insulated housing shown in FIG. 24, further showing the plurality of fodder-growth surfaces and support structure.

### DESCRIPTION OF REPRESENTATIVE EMBODIMENTS

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

### Example 1

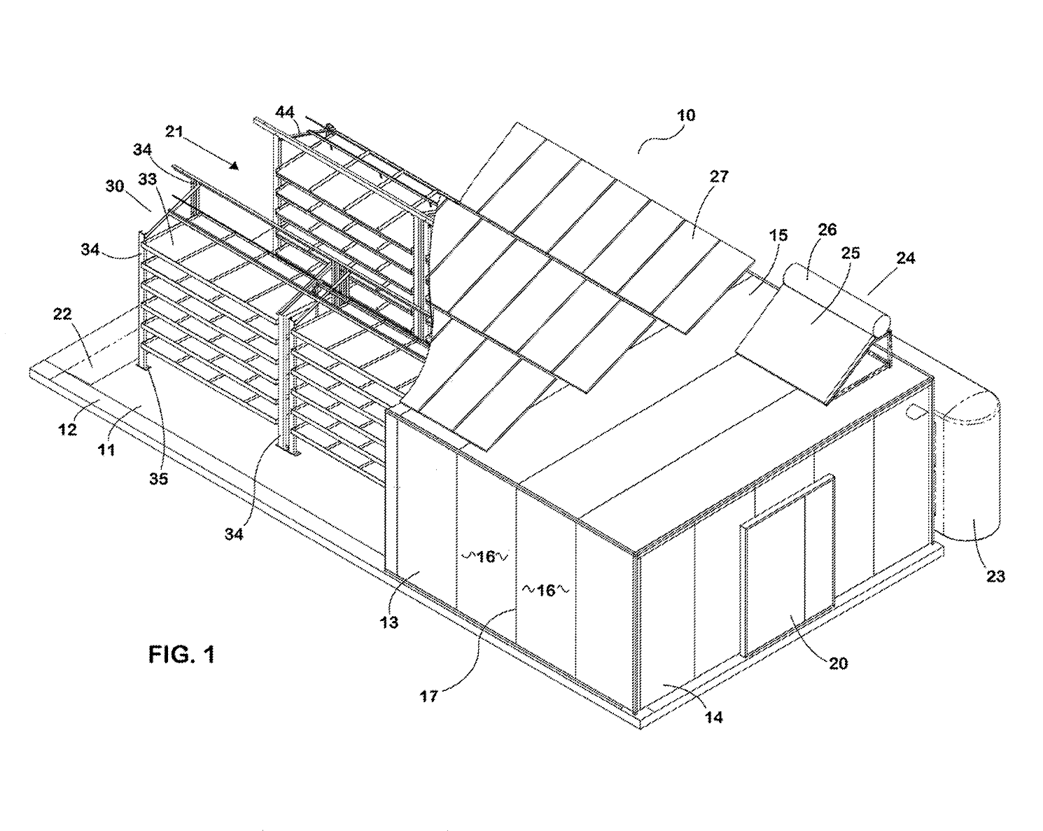

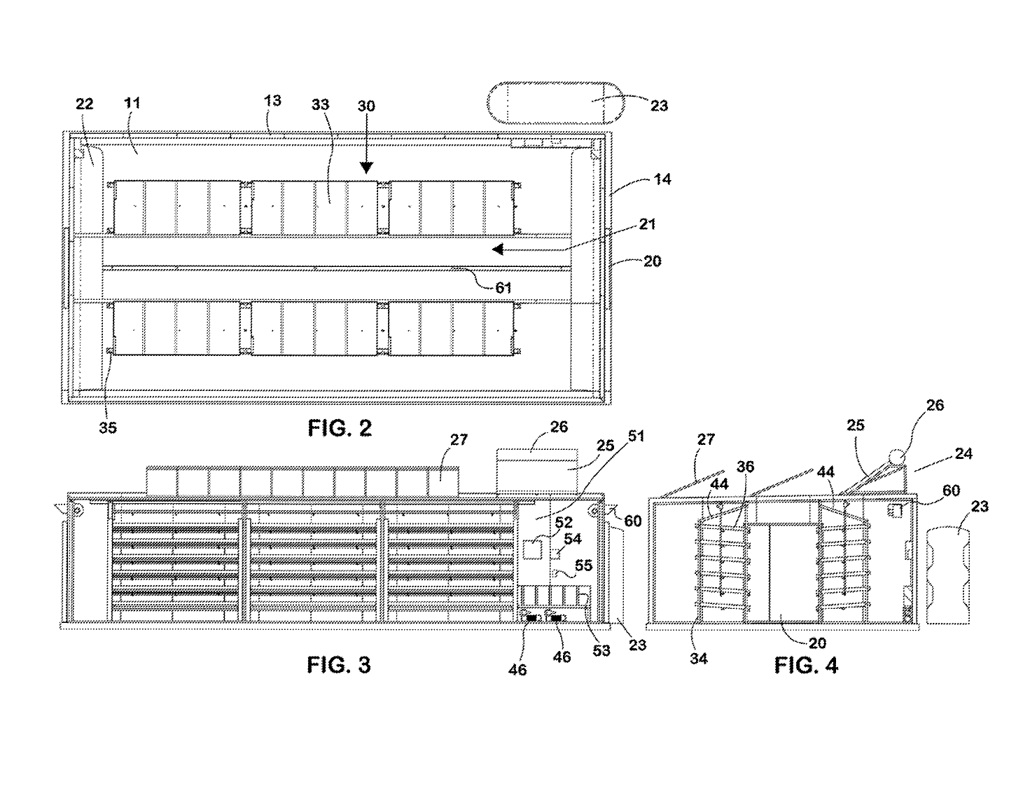

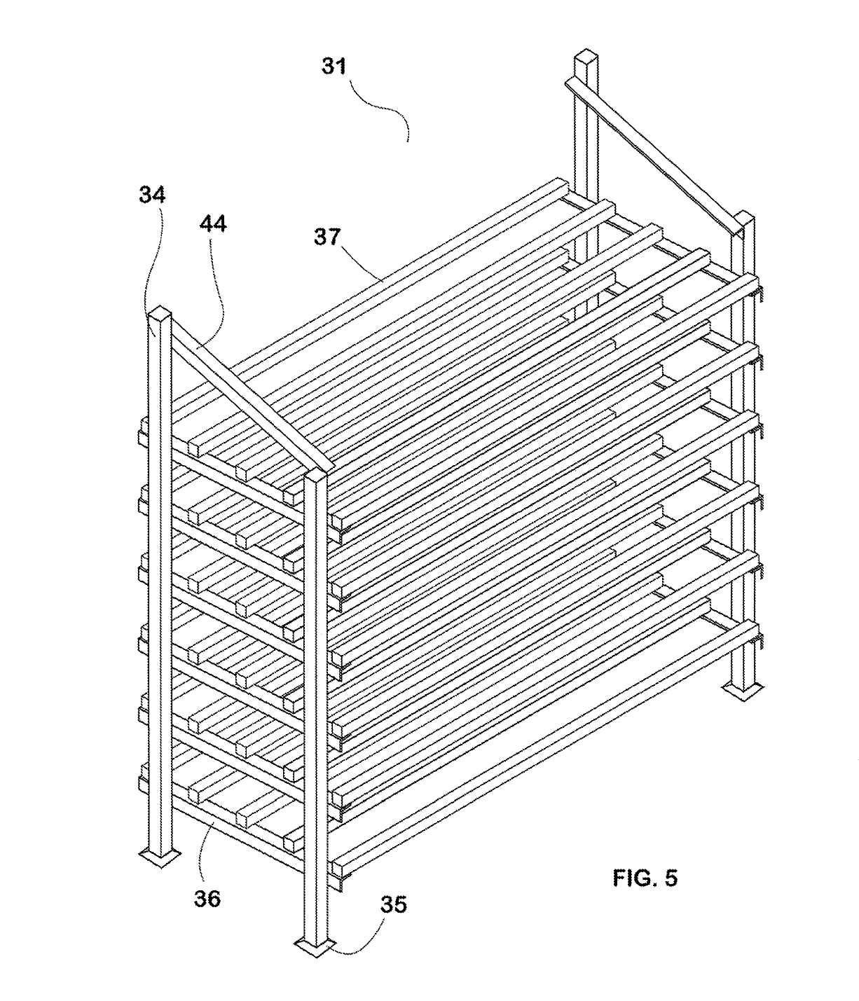

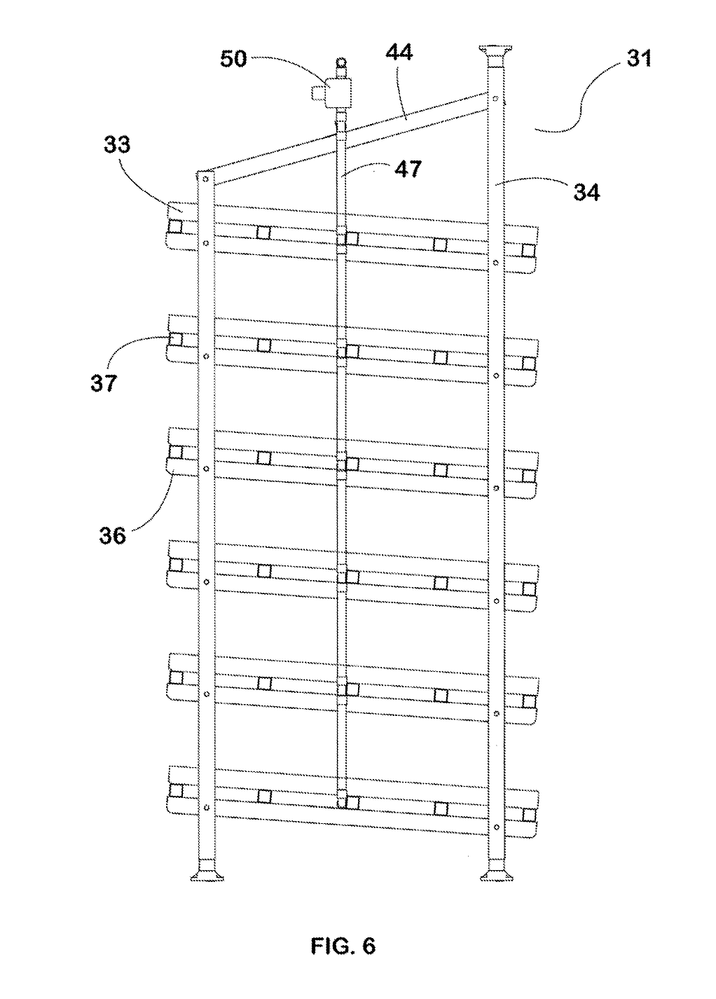

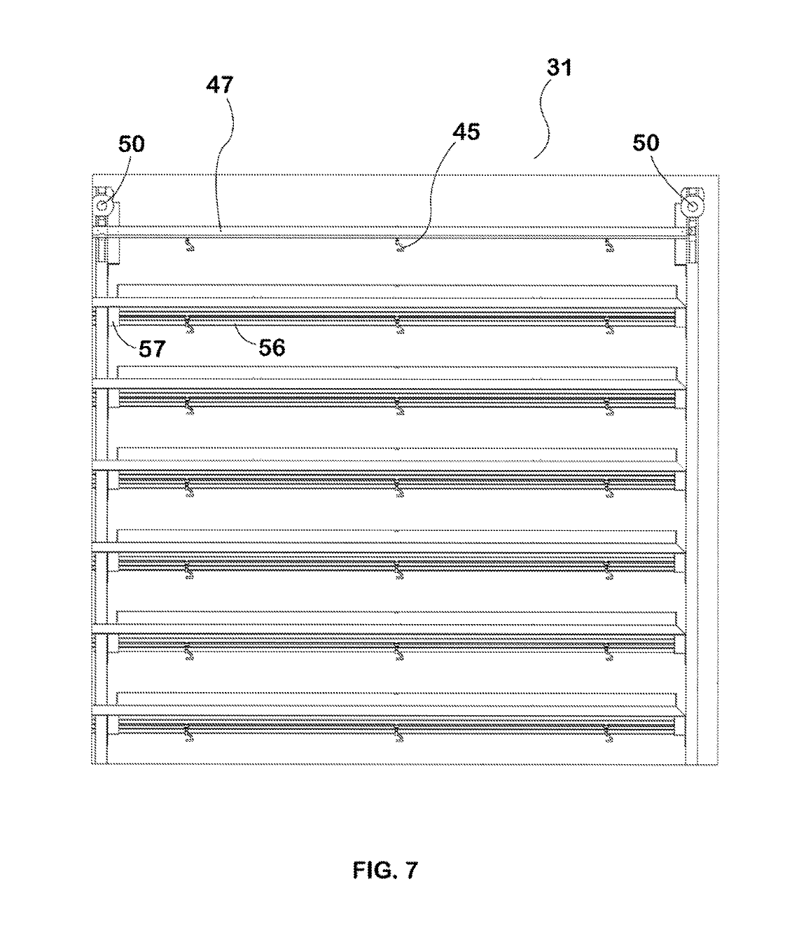

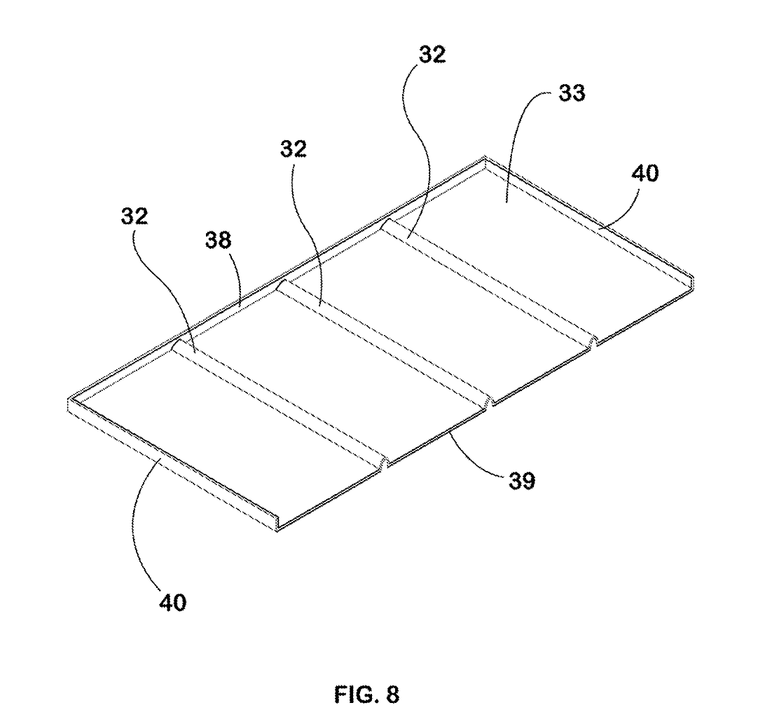

In the drawings of FIGS. 1 to 8 there is provided a fodder growing system 10 including a concrete slab-on-ground 11 and integral reinforced concrete edge beams 12. The edge beams 12 support an insulated enclosure comprising side walls 13, end walls 14 and a top wall 15, each comprising a plurality of metal skinned insulated panels 16 supported on metal frame members at the panel joins 17. The end walls 14 each have an insulated door 20; when the respective doors 20 are opened, an end-to end passage 21 is defined through the enclosure. A height difference between the edge beams 12 and the slab 11 at the doors 20 is matched by integral concrete ramps 22. By this means a wheeled trolley or the like may pass through the enclosure from one end to the other.

To the outside of the enclosure is located a water storage tank 23, supplied at least in part by rain water collected on the top wall 15. An electrically boosted solar thermal water heater 24 is mounted on the top wall 15 and comprises a thermal solar collector 25 heating an insulated accumulator tank 26. A solar PV panel array 27 generates electrical power to meet the electrical energy needs of the fodder growing process, excess electrical energy being stored in a bank of deep cycle storage batteries.

Arranged on each side of the end-to-end passage 21 are growing assemblies 30, in this case each comprising a metal frame assembly 31 each supporting six ABS polymer moulded platform members 33.

The rack assemblies each include two pairs of spaced uprights 34 formed of 40×40×3 mm RHS aluminium, supported on load pads 35 on the slab 11.

The platform members 33 are supported on aluminium angle frame portions 36 welded to the uprights 34 and then to five spaced RHS aluminium stringers 37. While on a loading basis, fewer stringers are required. However, the use of stringers in excess of those needed strictly for mechanical strength contributes to the thermal mass of the apparatus, buffering the heating loads. The platform members 33 are screwed to the stringers 37 with self-drilling and tapping fixings.

The platform members 33 are present an upper surface at an inclination of about 4° downward toward the free edge of the platform member 33. As the platform members 33 are substantially parallel, as are the uprights, the assembly is braced against collapse by a plurality of upper braces 44 each bolted between the uprights 34 forming a respective pair.

The platform members 33 are thermoformed from ABS sheet to 2400×1200 mm. The members 33 are formed with three 50 mm high dividing walls 32 extending from a 50 mm high rear wall portion 38 toward the front edge 39. The dividing wall portions 32 are thermoformed as a flattened re-entrant. 50 mm high end wall portions 40 are also provided. The dividing walls permit the mat to be of manageable weight when stripping out at the end of the fodder growing cycle.

An irrigation system connects the water storage tank 23 and the hot water accumulator tank 26 to a plurality of spray nozzles 45 supported over each of said platform members 33. The reticulation aspects of the irrigation system comprise a 140 kPA pressure-switch controlled water pump 46, one of which pumps water from the storage tank 23 through a heat exchange coil in the accumulator tank 26, and the other of which draws directly from the storage tank 23. Both pump 46 outlets feed an electronically controlled tempering valve (not shown) adapted to control the temperature of the combined outflow to a temperature selected by means described hereinafter. The combined outflow passes to the spray nozzles 45 via a piping manifold 47 including electronically controlled valves 50.

An integrated control assembly includes an environmental housing 51 containing a multichannel programmable logic controller (PLC), electrical distribution board, and a solar panel regulator. A user interface touch screen 52 interprets and provides user control over the PLC and provides historical and current system data. A bank of sealed AGM deep-cycle batteries 53 is charged by the solar panels 27 and in turn powers the control assembly, pumps 46 and other functions as described hereinafter. The environmental housing 51 is also provided with a master isolation switch 54 and a protected data port assembly 55 for programming via an external laptop or tablet device. The integrated control assembly includes switching power to an immersive electrolytic ozonation device associated with the water storage tank 23.

The water storage tank is dosed with food grade, non-ionic surfactant (Tween 60) and is maintained at between 0.05% v/v (hot weather) and 0.1% v/v (cold weather), having regard to the expected mixing ratio imposed by the tempering valve and the PLC controlling it.

The irrigation system is completely controllable by means of the PLC controlling a time cycle of irrigation, the PLC timer switching on irrigation by opening the electronically controlled valves 50. The pumps 46 per se are automatic; the pressure switches enable all flow control to be managed by PLC switching of the electronically controlled valves 50. This enables a constant head to be maintained to close to the nozzles 45, preventing drain-back and allowing precise control of volumes by time and cycle duration alone. The PLC controls precise dosing of the irrigation water with non-ionic surfactant downstream of the tempering valve.

A typical 6-day irrigation regime may be as per Table 1:

TABLE 1

| | Water Duration | Interval |
|---|---|---|
| | (sec) | (mins) |
| Day 1 | 10 | 20 |
| Day 2 | 15 | 30 |
| Day 3 | 20 | 30 |
| Day 4 | 30 | 60 |
| Day 5 | 30 | 60 |
| Day 6 | 30 | 90 |

The delivery of irrigation water over the 6 day program is selected to be between 2 and 3 litres per kg of grown sprouts.

Temperature control is invoked by PLC-interface screen 52-selecting an irrigation temperature at the electronically controlled tempering valve or by selecting a tempering valve program based on a temperature sensor in the housing, the apparatus being capable of either method of temperature control. In the present case, the tempering valve control by the PLC is set at about 23° C. when the fixed-method is chosen, and is selected to approximately average 23° C. when programmed for diurnal variation.

The illumination system comprises light emitting diodes (LEDs) 56 in 36-watt per meter strips comprising 1 blue (450 nm) LED for every 8 red (700 nm) LEDs. The strips of LEDs 56 are mounted to the stringers 37 over the platform member 33 below, except in the case of the top platform member 33 where the strip is mounted to a dedicated bracket 57. The strips, stringers 37 and brackets 57 cooperated to yield an average flux of 36 Wm⁻². The PLC is programmed to switch the LEDs over a 6-day growing cycle. Unlike prior art systems where illumination time is restricted to control mould growth, after the initial germination period of about 2 days when the illumination is turned off by the PLC, from the 2^{nd} to the 6^{th} days of a typical 6-day fodder growing cycle the illumination is on full-time.

A pair of exhaust blowers 60 under timer control by the PLC are operated to exchange two housing volumes of air per day for the first 2.5 days and one housing volume per day thereafter, in order to maintain oxygenation levels during the respiration-dominated germination phase of the growing cycle. In addition, the PLC coordinates operation of a UV air Ozonation device (not shown) with the air exchange exhaust blowers 60.

In order to prevent contamination and infection, there is no irrigation recycling; any non-absorbed irrigation water passes to waste via floor drains 61.

### Example 2

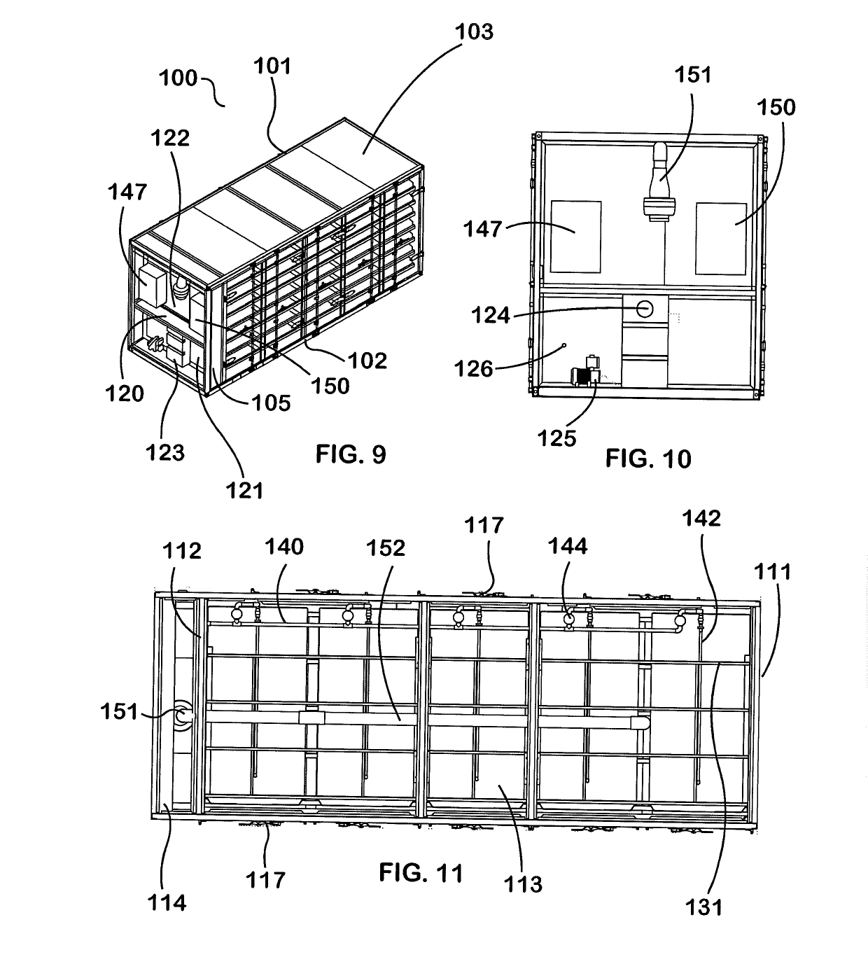

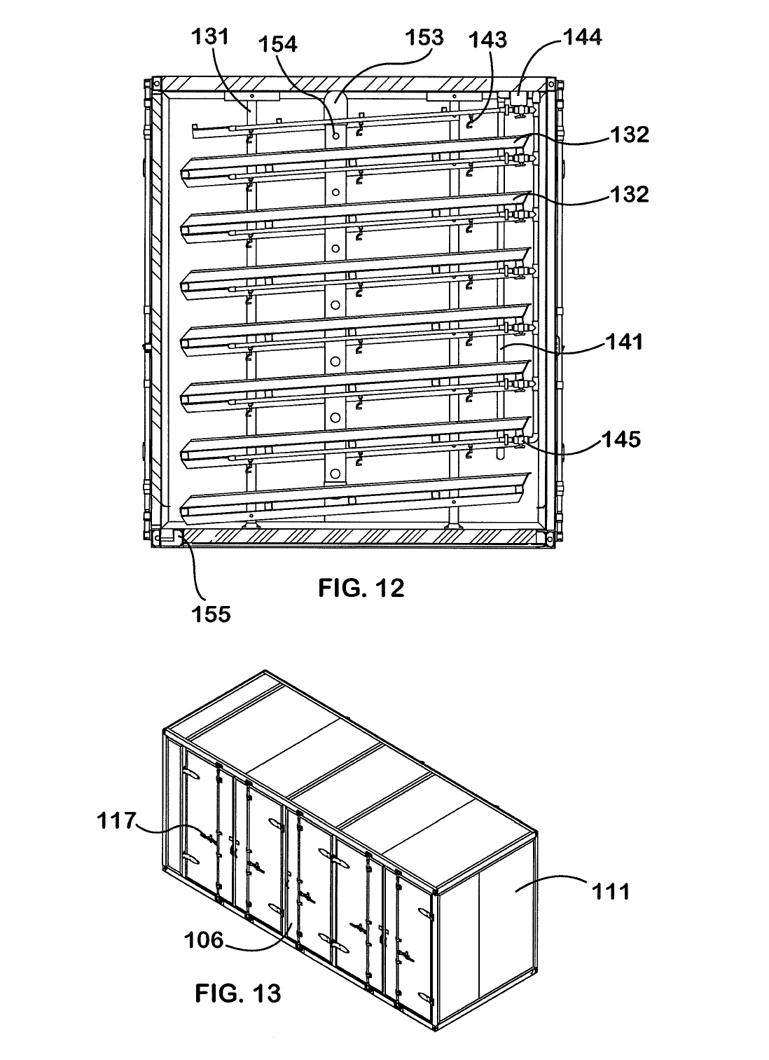

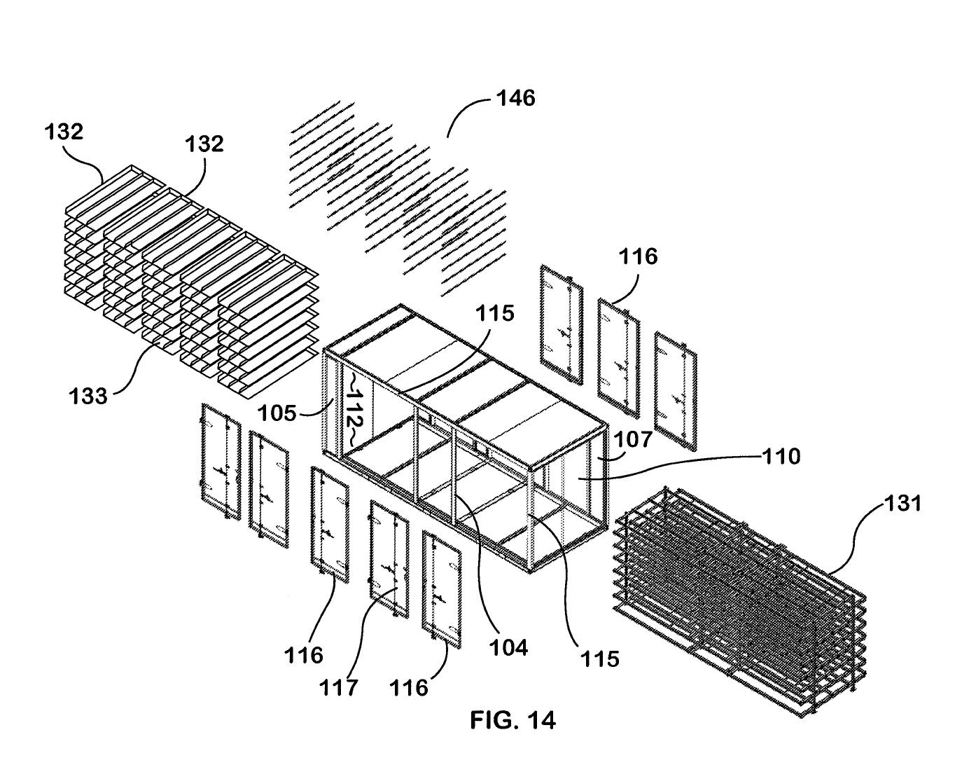

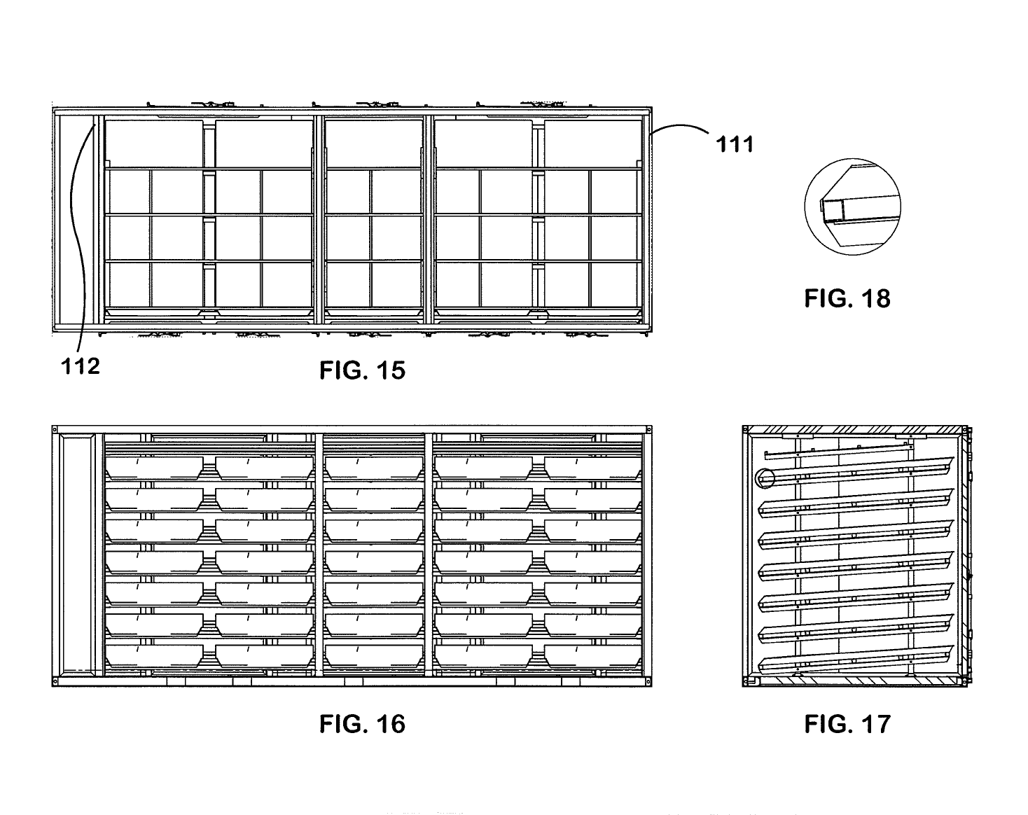

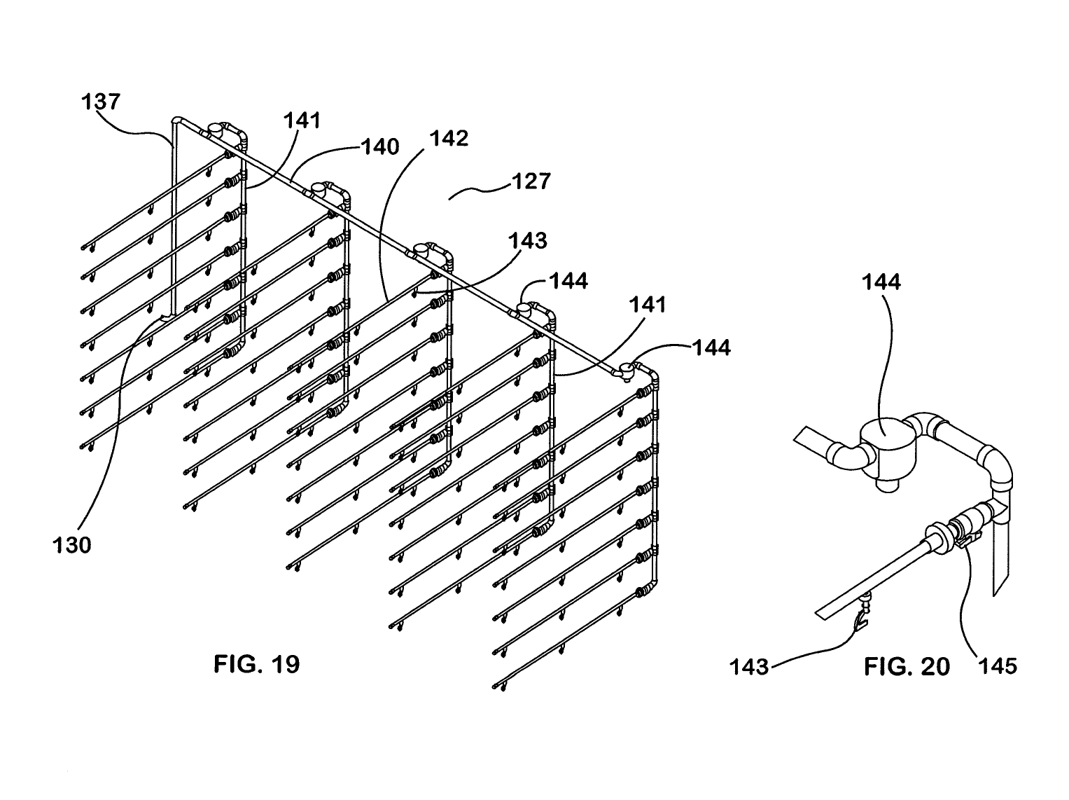

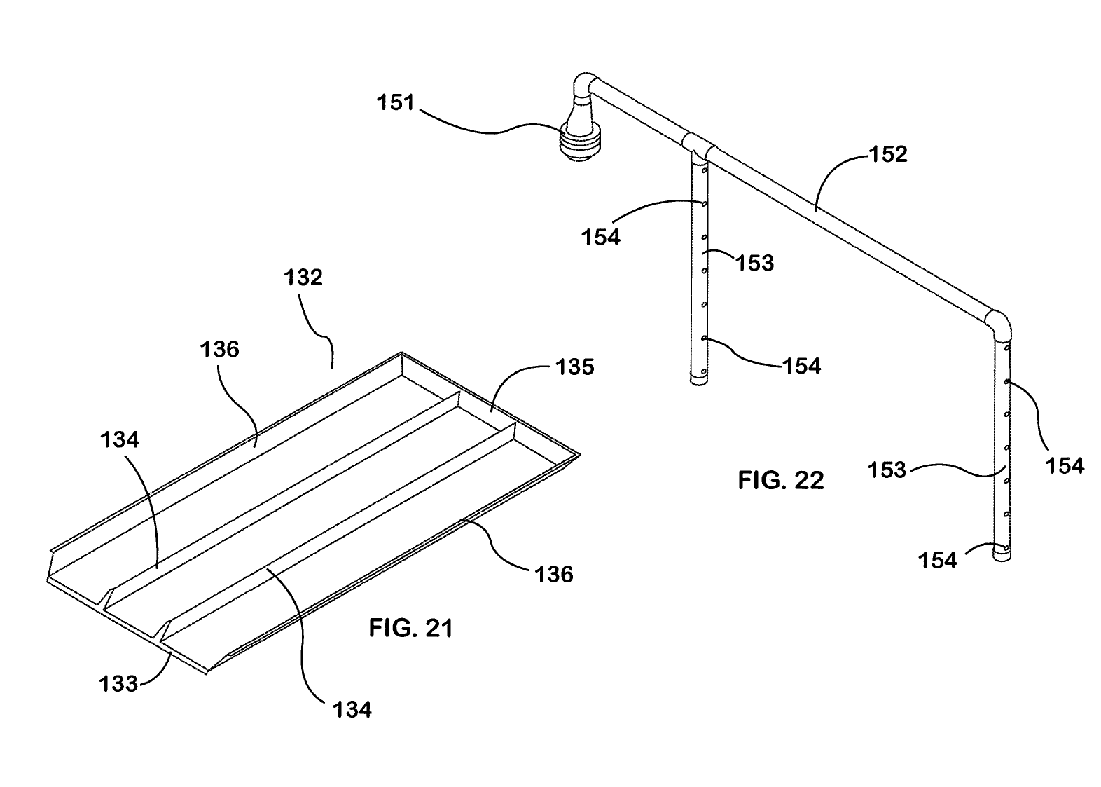

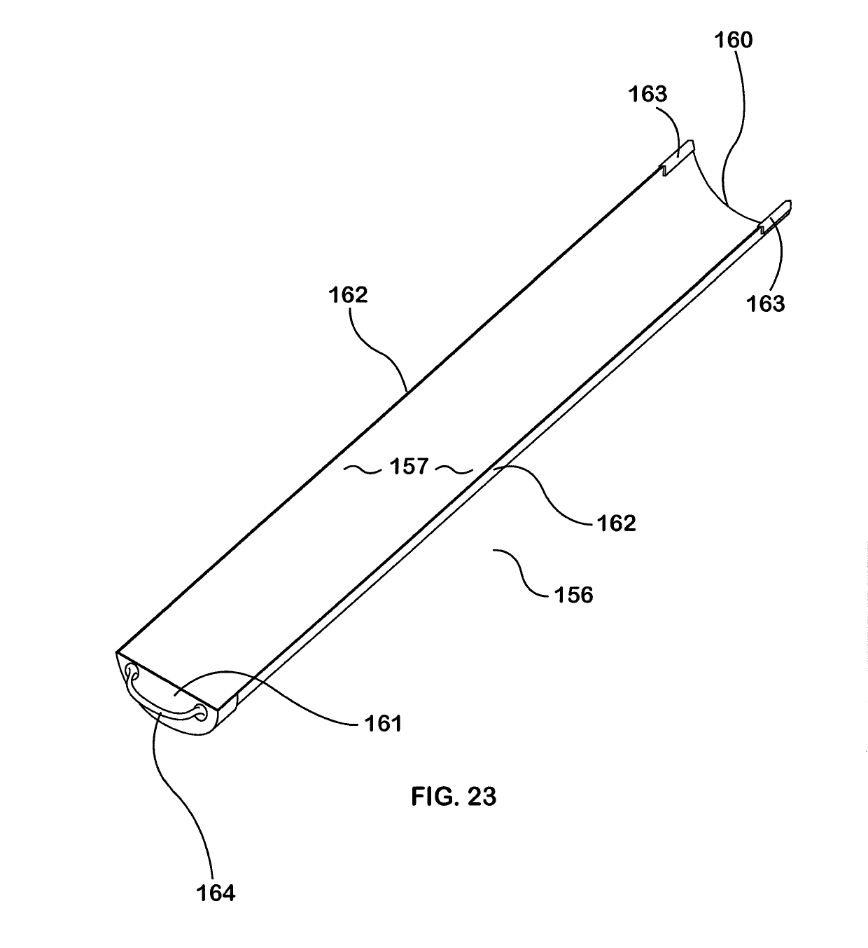

In the embodiment of FIGS. 9 to 23, there is provided an alternate fodder growing apparatus 100. In this embodiment, a steel framed, insulated housing 101 has the general planform of a 12 m (40′) ISO shipping container, having insulated floor 102 and roof 103 assemblies. Removable door frame members 104 and a side wall panels 105 space apart the floor 102 and roof 103 assemblies and define a first major side 106 of the housing 101, and further spaced side wall panels 107 similarly define a second major side 110 of the housing 101. An insulated end wall 111 closes an end of the housing 101. An insulated end bulkhead 112 closes the housing 101 short of an end, dividing the housing into two spaces generally described as a growing space 113 and an equipment space 114. The equipment space 114 is selectively closed by a roller door (omitted for clarity).

Doorways 115 between the removable door frame members 104 and a side wall panels 105 and the spaced side wall panels 106 of the first 106 and second 110 major side wall portions and reach selectively closed by an insulated container door assembly 116, each including a container door closure assembly 117.

The equipment enclosure 114 is divided by a horizontal partition 120 into a wet space 121 and an electrical space 122. A heated water storage tank 123 is provided with a filler/dosing port 124 and supplies a pump 125 which delivers water under pressure through the bulkhead 112 at grommet 126 to an irrigation assembly 127 at lead in conduit 130.

Within the housing 101 is arrayed a metal frame assembly 131 supporting five vertically spaced sets of seven ABS polymer moulded platform members 132. The platform members 132 present an upper surface at an inclination of about 5° downward toward a free front edge 133. The platform members 132 are thermoformed from ABS sheet of 2400×1200 mm dimension as in Example 1. However, the orientation is 90° to that of Example 1, to form deeper and narrower platforms extending substantially across a standard container width. The platform members 132 are formed with two 50 mm high dividing walls 134 extending from a 50 mm high rear wall portion 135 toward the front edge 133. The dividing wall portions 134 are thermoformed as a flattened re-entrant. 50 mm high side wall portions 136 diverge outward from the upper surface of the platform member and are substantially parallel to the dividing wall portions 134. The dividing wall portions permit the biscuit to be of manageable weight when stripping out at the end of the fodder growing cycle, and which may be further managed by, for example, cutting the biscuit with a serrated knife.

The irrigation assembly 127 comprises a main riser 137 connecting the lead in conduit 130 to a manifold 140 distributing irrigation water to the individual platform members 132 via a dedicated dropper line 141 for each set of platform members 132, each platform member being served by a spray bar 142 supplied from the dropper line 141 and having three spray heads 143. The water pump 125 maintains the irrigation assembly 127 at a static head of 140 kPA by pressure switch control Each dropper line 141 is controlled individually by a solenoid valve 144 so that each set may be individually tailored in the irrigation program. Each spray bar 142 may be isolated by a ball valve 145 to enable spray head 143 maintenance or replacement.

An illumination system comprises light emitting diode (LED) strips 146 of 36-watt per meter 1 blue (450 nm) LED for every 8 red (700 nm) LEDs. The strips 146 are mounted to the metal frame assembly 131 over the platform members 132. The strips 146 cooperate to yield an average flux of 36 Wm⁻².

The electrical space 122 includes a multi-channel programmable logic controller (PLC) 147, electrical distribution board 150 and ventilation blower 151. The PLC 147 has user programmable functions and pre-set functions, including switching power to an immersive electrolytic ozonation device associated with the water storage tank 123. The water storage tank is dosed with food grade, non-ionic surfactant (Tween 60) and is maintained at between 0.05% v/v (hot weather) and 0.1% v/v (cold weather). The tank is also dosed with root stimulant.

The PLC 147 is programmed to control a time cycle of irrigation and illumination, effected by opening the solenoid valves 144 and switching the LED strips 146 respectively.

A typical 5-day irrigation regime may be as per Table 2:

TABLE 2

| | Water Duration | Interval | |
|---|---|---|---|
| | (sec) | (mins) | Illumination |
| Day 1 | 10 | 20 | nil |
| Day 2 | 15 | 30 | nil |
| Day 3 | 20 | 30 | 1 hr: 1 hr on: off |
| Day 4 | 30 | 60 | 1 hr: 1 hr on: off |
| Day 5 | 30 | 60 | 1 hr: 1 hr on: off |
| Day 1 | Harvest/reseed | | |

In one method of use, the sets platforms 132 are loaded on sequential days, so that each set is on a different day of the 5-day cycle. The delivery of irrigation water over the 5 day program is selected to be between 2 and 3 litres per kg of grown sprouts. Temperature control is invoked in advance by the PLC 147 having input of ambient temperature data. The PLC 147 is programmed to switch the LED strips 146 over a 5-day growing cycle.

The ventilation blower 151 is under timer control by the PLC 147 and is operable to blow air through and air manifold 152 having two individual delivery pipes 153 having air jets 154 indexed with the spaces between the platform members 132 to positively displace respiration CO₂-containing air. The ventilation blower 151 is controlled to exchange a selected volume, such as two housing volumes of air per day.

In order to prevent contamination and infection, there is no irrigation recycling; any non-absorbed irrigation water passes to waste via floor drain 155.

A seed bed loader 156 is provided whereby a charge of seed suitable for a single biscuit is loaded on a platform 132 in the space between a side wall 136 and an intermediate dividing wall 134 of two dividing walls 134. The loader 156 is inserted over the selected platform 132 portion and operated to deposit seed preferentially away from the intermediate wall(s) 134.

The loader 156 comprises an elongate tray 157 (having a channel) of arcuate cross section, which is a little shorter than the distance from the rear wall 135 and front edge 133 of the platform 132. The width of the elongate tray 157 is less than the spaces between side walls 136 and intermediate walls 134. The elongate tray 157 has one open arcuate end 160 and one walled arcuate end 161. The opposed elongate edges 162 of the tray 157 supports short pieces of low friction plastic edging 163 at the open end 160. The walled arcuate end 161 bears a handle 164.

In use the seed mass (soaked if necessary) is loaded in to the loader tray 157 with a scoop. The loaded loader 156 is inserted between the vertically spaced platform members 132 and rotated by the handle 164 to dump the seed mass on the lower platform between a pair of intermediate walls or a side wall and intermediate wall, as the case requires. The inverted loader 156 may then be withdrawn with the low friction plastic edging 163 bearing on the platform 132 and the open arcuate end 160 serving to evenly distribute the seed bed on the platform 132.

The advantage of the 5 day cycle include the following,

1—Less risk of Mould

2—Higher Relative Feed Value

3—Higher levels of Starch left in grain

4—Higher Dry Matter

### Example 3

FIGS. 9 to 23 more generally show a fodder growing system 100 (fodder growing apparatus 100) that includes a transportable insulated housing 101 (housing 101), a fodder growing compartment located within the housing 101, closable openings 115, 116/117 (doorways 115 and door assemblies 116/117) for accessing the compartment, a plurality of plastic or metal fodder-growth surfaces 132 (platform members 132) supported within the compartment, and a growth surface support structure 131 in the form of a rack, shelving system, stand or frame (metal frame assembly 131).

The housing 101 includes a floor, a roof, a pair of spaced side walls extending between the roof and floor, and a pair of spaced end walls extending between the roof, floor and side walls. The side walls are of greater length than the end walls.

A first side wall has four closable openings 115, 116/117. A second side wall has 3 closable openings 115, 116/117. It is to be appreciated that other types of closable openings could be used and the number of closable openings could differ. For example, the closure could be in the form of a door, window, panel, shutter or flap. If in the form of a door, window, panel, shutter or flap, the door, window, panel, shutter or flap may be hinged to the side wall or other part of the housing so as to pivot about a vertical axis between the open and closed positions. Alternatively, the door, window, panel, shutter or flap may be hinged to the side wall or other part of the housing so as to pivot about a horizontal axis between the open and closed positions. If in the form of a roller door or shutter, the roller door or shutter may be mounted to a part of the housing (e.g. roof or side wall) such that the roller door or shutter may be raised and lowered (or otherwise moved) between the open and closed positions. If in the form of a sliding door, window, panel or shutter, the sliding door, window, panel or shutter may be slid substantially parallel with the side wall between the open and closed positions. If in the form of a fabric flap, the flap may be mounted to a part of the housing (e.g. roof or side wall) such that the flap may be moved between the open and closed positions.

Each fodder-growth surface 132 is adapted to support and grow fodder seeds so as to form a fodder mat. Each surface 132 has a fodder mat unloading end 133 (free front edge 133) accessible from outside the compartment by way of the closable openings 115, 116/117. Each surface 132 is inclined relative to the horizontal such that irrigation water can drain downwardly over the unloading end 133 and the fodder mat can be removed from the surface 132 by way of the unloading end 133.

Each surface 132 extends substantially across the entire compartment, substantially from one housing 101 side wall to the other, so as to maximise fodder growth area. The unloading end 133 of each surface 132 extends substantially parallel with a side wall or opening in the side wall. A growth area of each surface 132 on which fodder seed is grown is substantially flat/planar. Each surface 132 has a raised periphery or edge 135, 136 (rear wall portion 135, high side wall portions 136) extending from the unloading end 133 and around the growth area so as to contain fodder seed within the growth area so as to form a suitable fodder mat. Each surface 132 has dividing walls 134 (dividing wall portions 134) extending substantially perpendicularly of the unloading end 133 and separating one fodder growth area from another.

The surfaces 132 are supported/spaced above and along side one another to provide maximum growth area, but with the spacing nevertheless providing clearance for fodder growth, adequate irrigation and adequate lighting. Other surface 132 configurations can be used.

The plurality of fodder-growth surfaces 132 can be fixedly connected to the support structure 131 or connected to the support structure 131 for movement relative thereto. For example, the surface 132 may be connected to the support structure 131 by way of a rail or roller system, allowing movement and extension of the unloading end 133 through the closable opening 115, 116/117 and externally of the compartment. This may assist with initial seeding, growth inspection and/or unloading of the fodder mat, as well as cleaning and maintenance of the surfaces 132.

Each surface 132 may be downwardly inclined at any suitable angle relative to the horizontal, so as to enable drainage of water downwardly along a growth area of the surface. For example, the angle of inclination may be approximately 0.5°, 1°, 1.5°, 2°, 2.5°, 3°, 3.5°, 4°, 4.5°, 5°, 5.5°, 6° or even greater. In some embodiments the surfaces may be supported in a position inclined downward between 3° and about 6° from the horizontal.

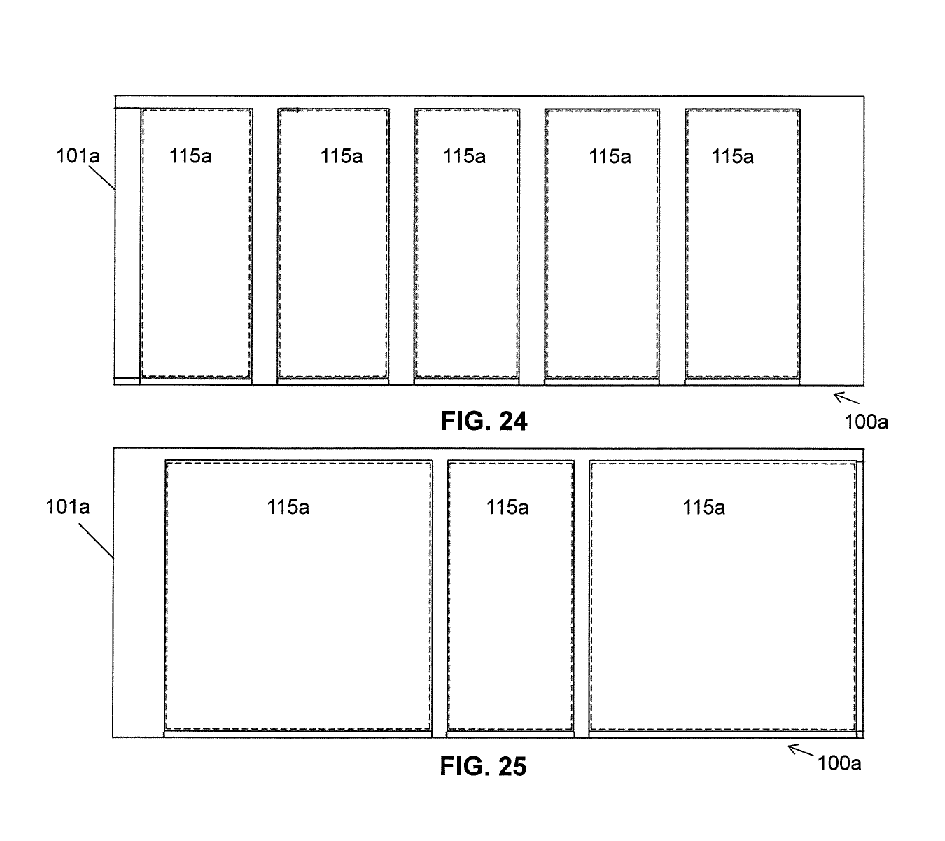

FIGS. 24 to 27 show part of a fodder growing system 100a, similar to system 100, that includes a transportable insulated housing 101a, a fodder growing compartment 200a located within the housing 101a, closable openings 115a (but only showing general outlines of doorways 115a) for accessing the compartment 200a, a plurality of plastic or metal fodder-growth surfaces 132a supported within the compartment 200a, and a growth surface support structure 131a in the form of a rack, shelving system, stand or frame.

The housing 101a includes a floor, a roof, a pair of spaced side walls extending between the roof and floor, and a pair of spaced end walls extending between the roof, floor and side walls. The side walls are of greater length than the end walls. The housing 101a has a floor drain 155a.

A first side wall (FIG. 24) has five closable openings, comprising five separate doorways 115a that are closed by 5 individual doors. A second side wall (FIG. 25) has three closable openings 115a, one of which is closed by an individual door and two of which are closed by double doors.

Each fodder-growth surface 132a is adapted to support and grow fodder seeds so as to form a fodder mat. Each surface 132a has a fodder mat unloading end 133a accessible from outside the compartment by way of the closable openings 115a. Each surface 132a is inclined relative to the horizontal such that irrigation water can drain downwardly over the unloading end 133a and the fodder mat can be removed from the surface 132a by way of the unloading end 133a.

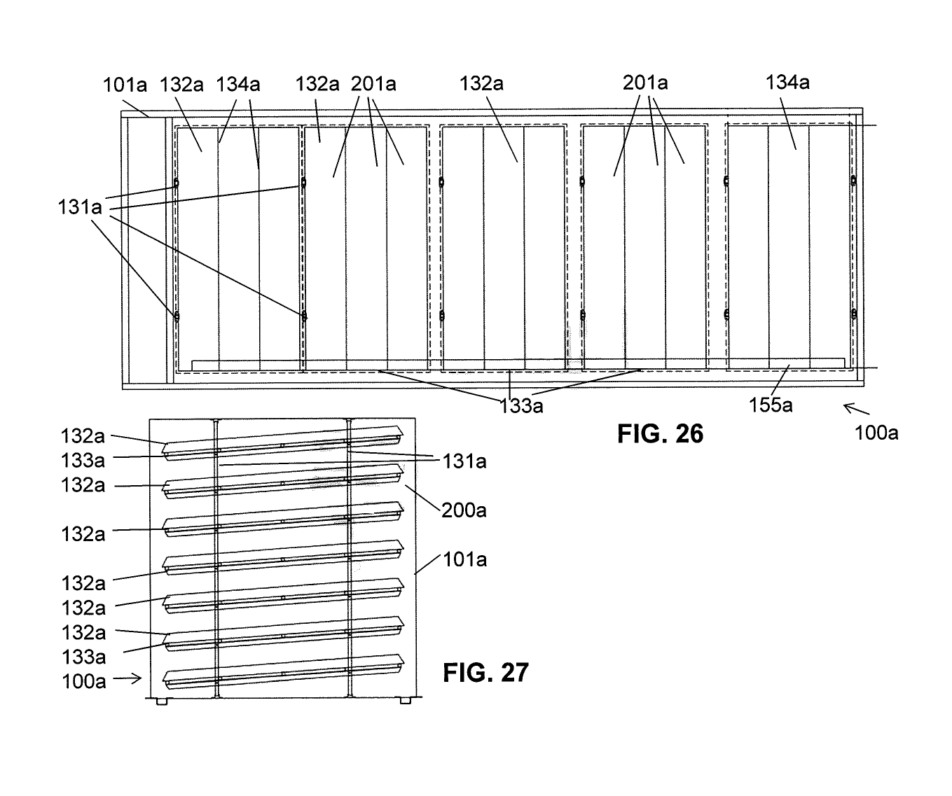

Each surface 132a extends substantially across the entire compartment, as seen in FIGS. 26 and 27, substantially from one housing 101a side wall to the other. A growth area 201a of each surface 132a on which fodder seed is grown is substantially flat/planar. Each surface 132a has a raised periphery or edge extending from the unloading end 133a and around the growth area 201a so as to contain fodder seed within the growth area 201a so as to form a suitable fodder mat. Each surface 132a has dividing walls 134a extending substantially perpendicularly of the unloading end 133a and separating one fodder growth area 201a from another.

Seven surfaces 132a are stacked above one another, as seen in FIG. 27. Five stacks of surfaces 132a are positioned alongside one another along a length of the compartment 200a, as seen in FIG. 26.

The plurality of fodder-growth surfaces 132a can be fixedly connected to the support structure 131a or connected to the support structure 131a for movement relative thereto. For example, the surface 132a may be connected to the support structure 131a by way of a rail or roller system, allowing movement and extension of the unloading end 133a through the closable opening 115a shown in FIG. 24 and externally of the compartment 200a. This may assist with initial seeding, growth inspection and/or unloading of the fodder mat, as well as cleaning and maintenance of the surfaces 132a and support structure 131a.

Each surface 132a may be downwardly inclined at any suitable angle relative to the horizontal, so as to enable drainage of water downwardly along a growth area 201a of the surface 132a. For example, the angle of inclination may be approximately 0.5°, 1°, 1.5°, 2°, 2.5°, 3°, 3.5°, 4°, 4.5°, 5°, 6° or even greater.

Advantages of the transportable fodder growing system 100, 100a as exemplified include:

1. The system is transportable.

2. Fodder growing area is maximised.

3. Fodder growth surfaces 132, 132a can be stacked/configured as required.

4. Single fodder mats can be grown on each surface 132, 132a across the compartment.

5. Fodder mats can be easily accessed and removed via the side walls.

6. The surfaces 132, 132a and support structure 131, 131a can be readily accessed for cleaning and maintenance via both side walls of the housing 101, 101a.

Particular terminology used when describing certain features or aspects of the invention should not be taken to imply that the terminology is being redefined herein to be restricted to any specific characteristics, features, or aspects of the invention with which that terminology is associated. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above.

The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention. Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein.

As noted above, particular terminology used when describing certain features or aspects of the invention should not be taken to imply that the terminology is being redefined herein to be restricted to any specific characteristics, features, or aspects of the invention with which that terminology is associated. While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

1. A fodder growing system comprising:
an insulated housing having a draining floor portion and at least one loading and unloading opening;
a plurality of vertically-spaced platforms supported in said housing, each platform being bounded by spaced end wall portions interconnected by a rear wall portion and an open front edge portion, the platforms being supported in a position inclined downwardly from said rear wall to said front edge, said front edges being accessible from said opening;
an irrigation system including spray nozzles supported over each of said platforms and supplied with water;
an illumination system supported over each of said platforms;
a ventilation system including forced ventilation means; and
a programmable controller selected to deliver a time-variant program of at least irrigation, lighting and temperature control.

2. The fodder growing system of claim 1, wherein the housing resembles a transportable shipping container.

3. A fodder growing system comprising:
a transportable insulated housing having:
a floor, a roof, a pair of spaced side walls extending between the roof and floor, and a pair of spaced end walls extending between the roof, floor and side walls, wherein the side walls are of greater length than the end walls;
a fodder growing compartment located within the housing;
at least one closable opening in at least one of the side walls for accessing the compartment; and
a plurality of fodder-growth surfaces supported within the compartment, each surface being adapted to support and grow fodder seeds so as to form a fodder mat, wherein each said surface has a fodder mat unloading end accessible from outside the compartment by way of the at least one closable opening, and each said surface is inclined relative to the horizontal such that irrigation water can drain downwardly over the unloading end and the fodder mat can be removed from the surface by way of the unloading end.

4. The fodder growing system of claim 3, wherein the housing resembles a transportable shipping container.

5. The fodder growing system of claim 3, wherein the at least one closable opening is provided by an opening in a said side wall and a closure that is movable between open and closed positions relative to the opening in said side wall.

6. The fodder growing system of claim 5, wherein each said side wall has a plurality of said at least one closable opening comprising a door and doorway.

7. The fodder growing system of claim 3, wherein each said surface extends substantially across the entire compartment from one said side wall to the other.

8. The fodder growing system of claim 3, wherein the plurality of surfaces are supported above one another.

9. The fodder growing system of claim 8, wherein the plurality of surfaces are supported along side one another.

10. The fodder growing system of claim 3, further including a support structure for supporting the plurality of surfaces, said support structure being selected from the group consisting of a rack, shelving system, stand and frame.

11. The fodder growing system of claim 3, wherein the housing includes a drainage system for removal of waste water from within the compartment.

12. A seed loader comprising:
an elongate tray having a channel for holding seed, wherein the tray has an open end at one end of the channel, and a closed end at an opposed end of the channel;
a longitudinal axis extending within the channel; and
a handle extending from the closed end, enabling the elongate tray to be rotated about the longitudinal axis, so as to discharge the seed from within the channel.

13. The seed loader of claim 12, wherein the tray/channel has an arcuate cross section.

14. The seed loader of claim 12, further including a friction edging adjacent the open end.

15. The fodder growing system of claim 1, wherein the housing comprises a building having a floor, two opposed end walls and two opposed side walls interconnecting the end walls, the side and end walls being formed of insulated panels, an insulated-panel top wall comprising both roof and ceiling of the building, and a pair of doors selectively closing respective opposed openings in the end walls.
